(19) United States
(12) Patent Application Publication
(10) Pub. No.: US 2012/0273655 A1
(43) Pub. Date: Nov. 1, 2012

(54) IMAGE SENSING APPARATUS AND CONTROL METHOD THEREOF

(75) Inventor: Makoto Ise, Tokyo (JP)

(73) Assignee: CANON KABUSHIKI KAISHA, Tokyo (JP)

(21) Appl. No.: 13/446,281

(22) Filed: Apr. 13, 2012

(30) Foreign Application Priority Data
Apr. 26, 2011 (JP) 2011-098675

(51) Int. Cl. H01L 27/146

(52) U.S. Cl. 250/208.1

(57) ABSTRACT

An image sensing apparatus which has an effective pixel portion and a light-shielded pixel portion which is arranged at an end of the effective pixel portion, comprises a detection unit which detects a column offset component for each column by performing weighted average cyclic calculation on the column at the light-shielded pixel portion; a correction unit which corrects a column offset superimposed at the effective pixel portion by performing cyclic calculation while a plurality of frames inherit the detected column offset component, and subtracting a column offset component calculated in every cyclic calculation from an output signal of the effective pixel portion; and a control unit which divides the light-shielded pixel portion into a plurality of blocks for each pixel region to be read out by one frame, and controls a block to be read out for each frame.

### BACKGROUND OF THE INVENTION

1. Field of the Invention

The present invention relates to a noise reduction technique for a solid-state image sensor.

2. Description of the Related Art

Recently, image sensing apparatuses which record and reproduce image data obtained by a solid-state image sensor such as a CCD sensor or CMOS sensor have been developed actively and prevail widely. Image sensing apparatuses require higher resolutions and higher operation speeds regarding shooting of still images and moving images. To achieve this, the frequency of a driving signal for driving a solid-state image sensor, and driving frequencies for an analog signal processing circuit, A/D converter, digital signal processing circuit, and the like are rapidly increasing.

Also, improved usability is requested not to fail in shooting in various shooting scenes. For example, the shutter speed is increasing in order to follow an object moving quickly in a sport scene or prevent a camera shake in indoor shooting under low illumination. In addition, image sensing apparatuses require higher sensitivities to enable shooting in a place where flash photography is inhibited, such as a museum or aquarium.

An output from a solid-state image sensor contains noise of a column offset component (to be referred to as a column offset) which appears as vertical stripe noise owing to the structure. For example, a CCD sensor is known to have vertical stripe noise caused by a defect of a vertical transfer register, and a smear phenomenon generated upon incidence of strong light. An XY address sensor typified by a CMOS sensor generally has a structure in which signals of each selected row are read out from photoelectric conversion elements arrayed in a matrix via vertical output lines that are common to rows and different between columns. For this reason, a column offset readily occurs depending on variations of element characteristics different between columns.

FIG. 26 shows the basic circuit configuration of the readout portion of one pixel in a general solid-state image sensor.

Referring to FIG. 26, a photodiode 901 accumulates optical signal charges, and a transfer transistor 902 transfers the optical signal charges accumulated in the photodiode 901 to a floating diffusion (FD) 904. A reset transistor 903 resets the optical signal charges accumulated in the photodiode 901, and the floating diffusion 904 converts the optical signal charges into an FD potential. A pixel source follower 905 reads out the FD potential to a vertical output line connected to a column amplifier.

The vertical output line and column amplifier arranged for each column have different characteristic variations between columns, generating a column offset.

In addition, an output from an image sensor contains various noise generation factors. Examples are pixel defect noise arising from the photodiode, reset noise arising from the reset transistor, 1/f noise arising from the pixel source follower, and RTS (Random Telegram Signal) noise.

Reset noise is generated when the reset transistor is turned on, applied a predetermined reference voltage, and turned off. This noise can be removed by a well-known technique such as correlated double sampling (CDS circuit).

Both 1/f noise and RTS noise are random noise components generated while an electron is captured and then released in the interface level of the pixel source follower. 1/f noise has a power spectral density inversely proportional to the frequency, has larger power at lower frequencies, and thus can be greatly reduced by the CDS circuit. However, RTS noise is generated at an unspecified time interval, and remains unremoved by the CDS circuit. In general, the RTS noise occurrence frequency heavily depends on the pixel source follower, and tends to localize in a specific pixel source follower element. As the element size of the pixel source follower decreases, the RTS noise occurrence frequency rises. This characteristic serves as one inhibition factor against further downsizing of an image sensor.

Pixel defect noise is dark current noise arising from an impurity mixed in the photodiode, and may become white spot noise of very high level depending on the temperature and optical signal charge accumulation time. Pixel defect noise also remains unremoved by the CDS circuit.

As a technique concerning the noise measure, Japanese Patent Laid-Open No. 07-067038 discloses a technique for detecting and canceling a column offset superimposed on an image sensing signal. For this purpose, a storage unit is arranged to store image data of one horizontal period. Image data from optical black pixels of a solid-state image sensor in the vertical direction are integrated for the horizontal period and stored. Then, the stored image data of one horizontal period are subtracted from effective pixel data, thereby removing the superimposed column offset. Japanese Patent Laid-Open No. 2006-025148 discloses a method of increasing the column offset detection precision by detecting a column offset after removing the influence of a defective pixel exceeding a predetermined threshold from optical black pixels of a solid-state image sensor in the vertical direction.

As described above, as the sensitivity of an image sensing apparatus increases, a column offset needs to be detected at higher precision and removed from an image sensing signal. However, the technique in Japanese Patent Laid-Open No. 07-067038 does not consider the influence of noise contained in the column offset detection region, other than a column offset.

Japanese Patent Laid-Open No. 2006-025148 describes removal of the influence of a defective pixel contained in the column offset detection region, but does not mention a concrete measure when the occurrence frequency of RTS noise contained in the column offset detection region is high.

If pixel source followers each having a high RTS noise occurrence frequency are localized in the column offset detection region and RTS noise accounts for more than half the signal component, it is difficult to detect and remove noise later by signal processing. Even if noise can be removed, the omission of the signal component in this section decreases the column offset detection precision.

### SUMMARY OF THE INVENTION

The present invention has been made in consideration of the aforementioned problems, and realizes a noise reduction technique which detects and corrects only a column offset from an image sensing signal at high precision, and can contribute to power saving while keeping the image quality high with high sensitivity.

In order to sole the aforementioned problems, the present invention provides an image sensing apparatus which has an effective pixel portion in which a plurality of pixels are two-dimensionally arrayed in a row direction and a column direction, and a light-shielded pixel portion which is arranged at an end of the effective pixel portion in at least the column direction, the apparatus comprising: a column offset detection unit configured to detect a column offset component for each column by performing weighted average cyclic calculation on the column at the light-shielded pixel portion; a correction unit configured to correct a column offset superimposed at the effective pixel portion by performing cyclic calculation while a plurality of frames inherit the column offset component detected by the column offset detection unit, and subtracting a column offset component calculated in every cyclic calculation from an output signal of the effective pixel portion; and a control unit configured to divide the light-shielded pixel portion into a plurality of blocks for each pixel region to be read out by one frame, and control a block to be read out for each frame.

In order to sole the aforementioned problems, the present invention provides a control method of an image sensing apparatus which has an effective pixel portion at which a plurality of pixels are two-dimensionally arrayed in a row direction and a column direction, and a light-shielded pixel portion which is arranged at an end of the effective pixel portion in at least the column direction, the method comprising: a column offset detection step of detecting a column offset component for each column by performing weighted average cyclic calculation on a single column at the light-shielded pixel portion; a correction step of correcting a column offset superimposed at the effective pixel portion by performing cyclic calculation while a plurality of frames inherit the column offset component detected in the column offset detection step, and subtracting a column offset component calculated in every cyclic calculation from an output signal of the effective pixel portion; and a control step of dividing the light-shielded pixel portion into a plurality of blocks for each pixel region to be read out by one frame, and controlling a block to be read out for each frame.

According to the present invention, the influence of noise except for a column offset is removed from an image sensing signal as much as possible, and only the column offset is detected and corrected at high precision. The present invention can therefore implement a noise reduction technique capable of contributing to power reduction while keeping the image quality high with high sensitivity.

Further features of the present invention will become apparent from the following description of exemplary embodiments (with reference to the attached drawings).

### BRIEF DESCRIPTION OF THE DRAWINGS

FIG. 1 is a block diagram showing an image sensing apparatus according to an embodiment of the present invention;

FIG. 2 is a view showing the pixel array of a CMOS image sensor;

FIG. 3 is a circuit diagram showing the internal configuration of the CMOS image sensor;

FIG. 4 is a timing chart showing the readout signal of the CMOS image sensor;

FIG. 5 is a timing chart showing the overall sensor;

FIG. 6 is a circuit diagram showing a column offset detection circuit according to the first embodiment;

FIGS. 7A and 7B are views for explaining a column offset detection/correction operation according to the first embodiment;

FIG. 8 is a view for explaining correction calculation in column offset detection according to the first embodiment;

FIG. 9 is a graph for explaining an error amount generated by RTS noise according to the first embodiment;

FIGS. 10A and 10B are graphs for explaining the RTS noise occurrence frequency;

FIG. 11 is a graph for explaining the convergence characteristic of cyclic calculation according to the first embodiment;

FIGS. 12A and 12B are views for explaining a column offset detection/correction operation according to the second embodiment;

FIG. 13 is a view for explaining correction calculation in column offset detection according to the second embodiment;

FIG. 14 is a view for explaining a column offset detection/correction operation according to the third embodiment;

FIG. 15 is a view for explaining correction calculation in column offset detection according to the third embodiment;

FIG. 16 is a circuit diagram showing a column offset detection circuit according to the fourth embodiment;

FIGS. 17A and 17B are views for explaining a column offset detection/correction operation according to the fourth embodiment;

FIG. 18 is a view for explaining correction calculation in column offset detection according to the fourth embodiment;

FIG. 19 is a graph for explaining a column offset maximum value according to the fourth embodiment;

FIG. 20 is a circuit diagram showing a column offset detection circuit according to the fifth embodiment;

FIGS. 21A and 21B are views for explaining a column offset detection/correction operation according to the fifth embodiment;

FIG. 22 is a view for explaining correction calculation in column offset detection according to the fifth embodiment;

FIG. 23 is a view for explaining a weighted average process according to the sixth embodiment;

FIG. 24 is a view for explaining a column offset detection/correction operation according to the sixth embodiment;

FIG. 25 is a view for explaining correction calculation in column offset detection according to the sixth embodiment; and

FIG. 26 is a circuit diagram showing a basic circuit regarding the readout portion of one pixel in an image sensor.

### DESCRIPTION OF THE EMBODIMENTS

Embodiments of the present invention will be described in detail below. The following embodiments are merely examples for practicing the present invention. The embodiments should be properly modified or changed depending on various conditions and the structure of an apparatus to which the present invention is applied. The present invention should not be limited to the following embodiments. Also, parts of the embodiments to be described later may be properly combined.

[Apparatus Configuration]

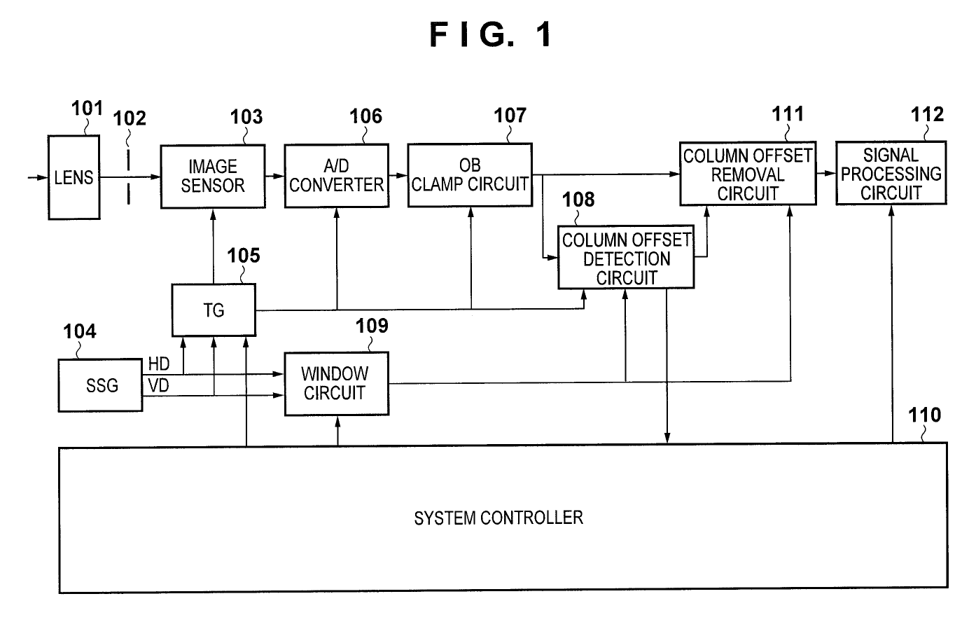

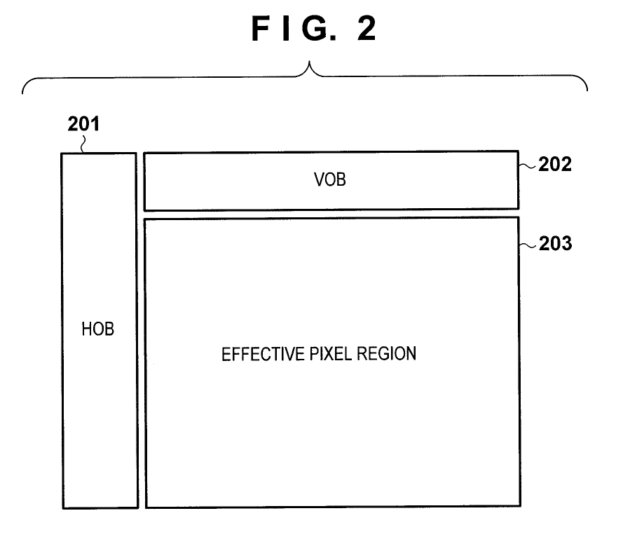

An image sensing apparatus according to the present invention is useful especially for a digital video camera and digital still camera (to be referred to as cameras). An example of applying the image sensing apparatus according to the present invention to a digital camera equipped with a CMOS image sensor will be described with reference to FIGS. 1 and 2.

Referring to FIG. 1, a lens 101 converges the optical image of an object onto the imaging surface of an image sensor 103. A stop 102 is driven to perform AE (Auto Exposure control) to adjust the optical amount of the object image, and keep a sensed image at an appropriate luminance level.

The image sensor 103 is a CMOS image sensor (to be referred to as a CMOS sensor) for converting the optical image of an object into an electrical signal.

As shown in FIG. 2, the CMOS sensor 103 has an effective pixel region 203 where light irradiates photodiodes serving as photoelectric conversion elements, as an effective pixel portion where a plurality of pixels are two-dimensionally arrayed in the row direction (horizontal direction) and column direction (vertical direction). Also, as light-shielded pixel portions arranged at ends of the effective pixel region 203 in the row and column directions, the CMOS sensor 103 has a horizontal optical black (to be referred to as HOB) region 201 where a light-shielding film such as an aluminum thin film shields several to several ten columns from irradiation of light, and a vertical optical black (to be referred to as VOB) region 202 where a light-shielding film such as an aluminum thin film shields several to several ten lines from irradiation of light.

A sync signal generator (to be referred to as SSG) 104 generates a horizontal sync signal (to be referred to as HD signal) and a vertical sync signal (to be referred to as VD signal).

A timing generator (to be referred to as TG) 105 generates various control signals in synchronism with the HD signal and VD signal to drive the CMOS sensor 103.

An A/D converter 106 converts an analog signal output from the CMOS sensor 103 into a digital image signal.

An OB clamp circuit 107 clamps the output value of the A/D converter 106 in the OB period at a predetermined value.

A column offset detection circuit 108 extracts, from the VOB region, a column offset component contained in an image signal output from the OB clamp circuit 107. A column offset removal circuit 111 subtracts the column offset detected by the column offset detection circuit 108 from the image sensing signal of the effective pixel region 203.

A window circuit 109 generates a control signal for driving the column offset detection circuit 108 and column offset removal circuit 111.

A system controller 110 executively controls the respective units, and determines an operation mode and parameters.

A signal processing circuit 112 performs interpolation processing, color conversion processing, and scaling processing such as reduction or enlargement for a digital image signal, and converts the digital image signal into an image signal displayable on a display device. In addition, the signal processing circuit 112 converts the image signal into JPEG image data or the like in accordance with a recording medium.

[Sensor Configuration]

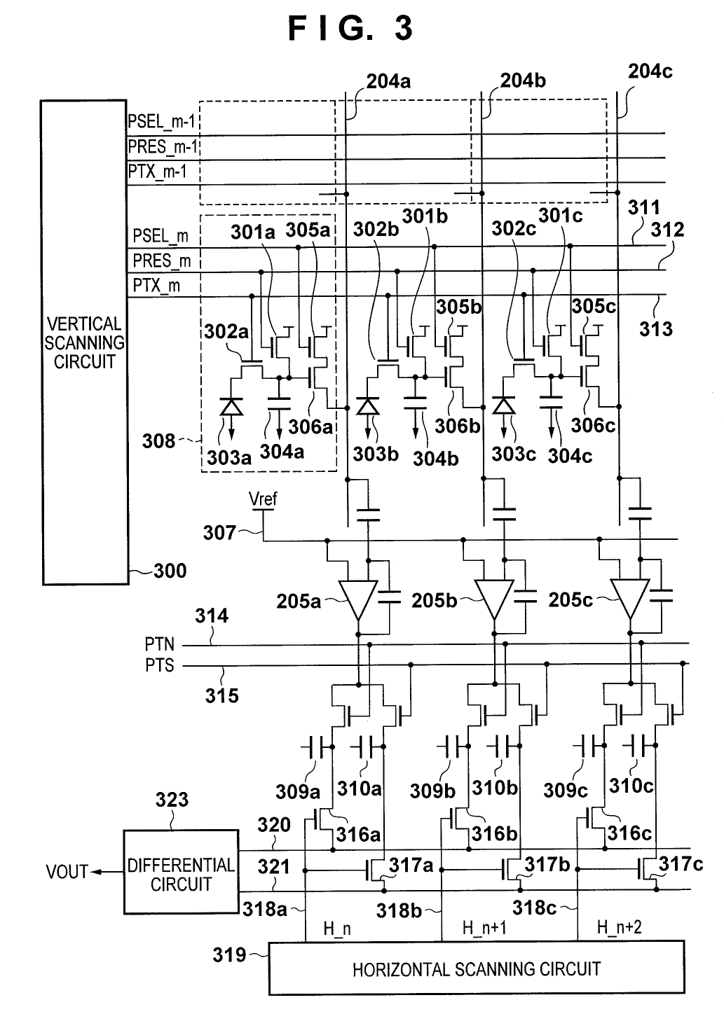

The circuit configuration of the CMOS sensor 103 will be explained with reference to FIG. 3. Referring to FIG. 3, a vertical scanning circuit 300 selects a specific readout row from the pixel array. Reset transistors (to be referred to as reset Trs) 301a to 301c reset optical signal charges accumulated in photodiodes. Transfer transistors (to be referred to as transfer Trs) 302a to 302c transfer optical signal charges accumulated in the photodiodes to floating diffusions (to be described later).

Photodiodes (to be referred to as PDs) 303a to 303c are formed from photoelectric conversion elements. Floating diffusions (to be referred to as FDs) 304a to 304c convert optical signal charges into FD potentials. Selection transistors (to be referred to as selection Trs) 305a to 305c select a specific row, operate pixel source followers, and read out FD potentials to vertical output lines 204a to 204c.

Pixel source followers (to be referred to as pixel SFs) 306a to 306c are buffer amplifiers which read out FD potentials to the vertical output lines.

A reference voltage Vref 307 is used as a reference for amplifying signals by column amplifiers 205a to 205c. A range surrounded by a broken line 308 serves as the building unit of one pixel of the readout circuit. Sample and hold circuits (to be referred to as S/H(N)s) 309a to 309c store N signals. Sample and hold circuits (to be referred to as S/H(S)s) 310a to 310c store S signals.

An mth row selection line (to be referred to as PSEL_m) 311, mth row reset signal line (to be referred to as PRES_m) 312, and mth row signal transfer line (to be referred to as PTX_m) 313 are signal lines for controlling the CMOS sensor 103. A signal line (to be referred to as PTN) 314 determines the period of readout to the S/H(N) 309. A signal line (to be referred to as PTS) 315 determines the period of readout to the S/H(S) 310.

Selection transistors (to be referred to as selection Trs) 316a to 316c select outputs from the S/H(N)s 309 on respective columns, and read them out to a horizontal output line 320. Similarly, selection transistors (to be referred to as selection Trs) 317a to 317c select outputs from the S/H(S)s 310 on respective columns, and read them out to a horizontal output line 321.

A horizontal scanning circuit 319 selects specific readout columns from outputs from the S/H(N)s 309 and S/H(S)s 310 on respective columns. The horizontal scanning circuit 319 outputs selection signals Hn to Hn+2 for nth to (n+2)th columns to signal lines 318a to 318c.

A differential circuit 323 receives signals from the horizontal output lines 320 and 321, and outputs a differential output as an output VOUT of the CMOS sensor 103.

Note that the building unit 308 of one pixel includes four transistors. Alternatively, the selection Tr 305 can be omitted using a method of inactivating/activating a pixel SF using two or more types of reset voltages. As another structure, a plurality of PDs may share an FD and SF.

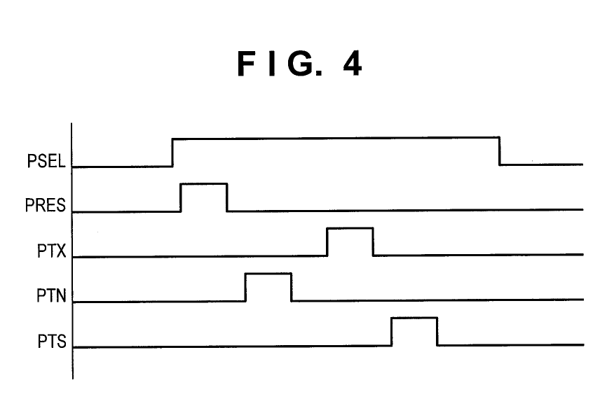

The operation timings of the signal lines in FIG. 3 in readout will be explained with reference to FIGS. 3 and 4.

When a shooting operation starts and light enters the PDs 303a to 303c, optical signal charges are generated and accumulation starts. The vertical scanning circuit 300 sequentially scans respective rows. When the scan comes to the mth row, the PRES_m 312 changes to high level, and the signals of the FDs 304a to 304c are reset.

Then, the PSEL_m 311 changes to high level, and reset levels containing reset noise are read out to the vertical output lines 204a to 204c via the pixel SFs 306a to 306c. The column amplifiers 205a to 205c amplify the differences between the reset levels read out to the vertical output lines 204a to 204c and the reference voltage Vref 307, and output the amplified differences.

The output N signals are stored in the S/H(N)s 309 in the high-level period (to be referred to as N readout period) of the PTX_m 313. Thereafter, the PTX_m 313 changes to high level, and charges generated in the PDs 303a to 303c are read out to the FDs 304a to 304c. Similar to the N signals, S signals output after passing through the pixel SFs 306a to 306c, vertical output lines 204a to 204c, and column amplifiers 205a to 205c are stored in the S/H(S)s 310 in the high-level period (to be referred to as S readout period) of the PTS_m.

The mth-row N signals of the respective columns that have been read out and stored in the S/H(N)s 309 are sequentially read out to the horizontal output line 320 for the respective columns via the selection Trs 316a to 316c which are controlled by the output signals 318a to 318c from the horizontal scanning circuit 319.

Similarly, the mth-row N signals of the respective columns that have been read out and stored in the S/H(S)s 310 are sequentially read out to the horizontal output line 321 for the respective columns via the selection Trs 317a to 317c which are controlled by the output signals 318a to 318c from the horizontal scanning circuit 319.

The mth-row N and S signals read out in parallel for the respective columns are input as differential signals to the differential circuit 323. A differential output from the differential circuit 323 serves as the output VOUT of the CMOS sensor 103.

The S signal is obtained by adding, to the N signal, a signal of optical signal charges generated in each of the PDs 303a to 303c. The differential operation between the S and N signals can achieve a CDS operation. Reset noise and 1/f noise arising from elements are removed from the output VOUT of the CMOS sensor 103. Then, an image sensing signal is output while pixel defect noise and RTS (Random Telegram Signal) noise are superimposed on the image sensing signal in addition to a column offset.

### First Embodiment

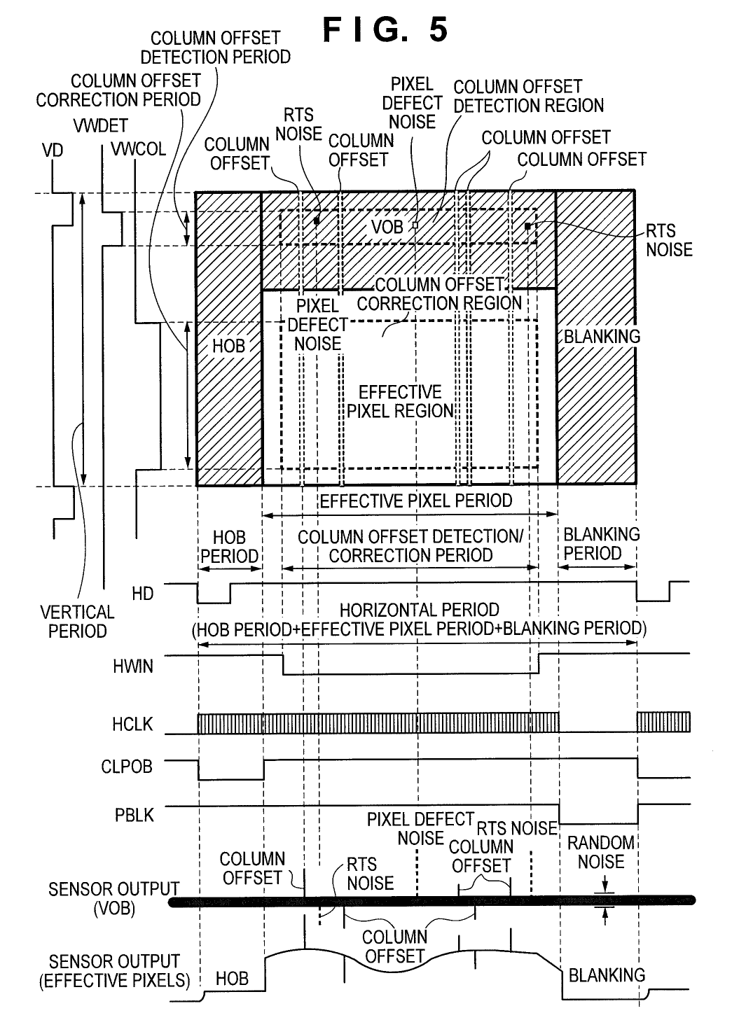

The operation of an image sensing apparatus according to the first embodiment will be described with reference to FIG. 5.

FIG. 5 is a view exemplifying a timing signal for a CMOS sensor 103 and a signal output in synchronism with the timing signal in the embodiment.

In FIG. 5, a TG 105 generates, from an HD signal and VD signal generated by an SSG 104, various control signals for driving the CMOS sensor 103. The CMOS sensor 103 converts an optical signal having passed through a lens 101 and stop 102 into an electrical signal at the timing of a control signal generated by the TG 105.

An A/D converter 106 converts an analog signal read out from the CMOS sensor 103 into a digital signal. After an OB clamp circuit 107 clamps the OB period at a predetermined level, the digital signal is output to a column offset detection circuit 108 and column offset removal circuit 111.

A window circuit 109 refers to the HD signal and VD signal and supplies, to the column offset detection circuit 108, a detection permission signal VWDET for designating the vertical detection period of a column offset in the VOB region, a detection permission signal HWIN for designating the horizontal detection period, and a pulse signal CCLK for counting cyclic calculation operations.

The window circuit 109 supplies, to the column offset removal circuit 111, a removal permission signal VWCOL for designating the vertical column offset removal period in the effective pixel region, and a removal permission signal HWIN for designating the horizontal column offset removal period.

The column offset detection circuit 108 calculates column offset data in accordance with a detection permission signal supplied from the window circuit 109.

The column offset removal circuit 111 subtracts and removes a column offset component calculated for each column by the column offset detection circuit 108 from the image sensing signal of the effective pixel region in accordance with the removal permission signal VWCOL supplied from the window circuit 109.

A signal processing circuit 112 performs signal processing for image data output from the column offset removal circuit 111, and converts it into image data suited to a display device and recording device.

In addition to the HD signal and VD signal serving as sync signals, the TG 105 supplies, to the CMOS sensor 103, an HCLK signal serving as a clock signal for reading out a signal from the CMOS sensor 103 for each pixel.

The HCLK signal is a readout control signal for controlling a sensor output in every one-pixel cycle to read out pixel signals from the HOB, VOB, and effective pixel regions serving as internal building elements of the CMOS sensor 103, and stopping a sensor output in the readout inhibition period.

The TG 105 further supplies, to the OB clamp circuit 107, a control signal (CLPOB signal) for selecting and extracting pixel signals serving as the black reference of a sensor output from the VOB and HOB regions.

The OB clamp circuit 107 subtracts HOB and VOB pixel signals extracted based on the CLPOB signal, from the image sensing signal of the effective pixel region, and then outputs the image sensing signal. As a result, a stable sensor output free from black level fluctuations can be obtained.

The timing of a PBLK signal indicates a blanking period Tblk during which readout of a sensor output stops during one horizontal period.

As described in Description of the Related Art, the CMOS sensor 103 readily generates a so-called column offset in which offsets different between columns are superimposed in accordance with variations of element characteristics different between readout columns owing to an XY address readout structure. The column offset is generated equally on each column sharing the readout paths of the VOB region, HOB region, and effective pixel region.

In addition to the column offset, pixel defect noise and RTS noise are superimposed on an output from the CMOS sensor 103. Further, random noise such as quantization noise in an analog circuit subsequent to the sensor or upon A/D conversion is superimposed.

The waveforms of a sensor output (VOB) and sensor output (effective pixel region) in FIG. 5 schematically represent the forms of the column offset and other noise components superimposed on these sensor outputs.

The gist of the present invention is to exclude unwanted noise components from the sensor output of the VOB region on which the column offset and other noise components are superimposed, and detect only the column offset at high precision without expanding the VOB region regarding one frame to prevent a decrease in moving image frame rate.

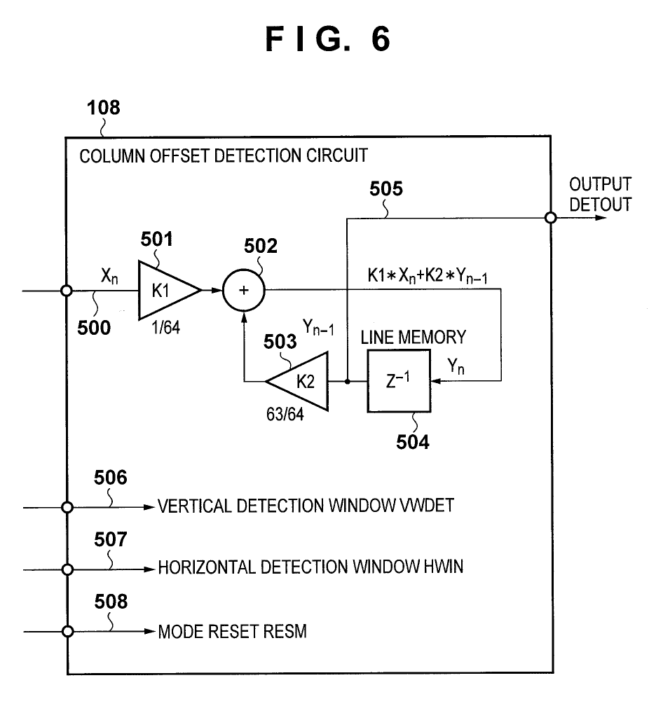

FIG. 6 shows the circuit configuration of the column offset detection circuit 108 for implementing the present invention.

Referring to FIG. 6, an image sensing signal Xn input to the column offset detection circuit 108 is input to a multiplier 501 (coefficient K1) via a signal line 500. An output (coefficient K1) from the multiplier 501 and an output from a multiplier 503 (coefficient K2) are input to an adder 502. An output from the adder 502 is input to a line memory 504. An output from the line memory 504 is input to the multiplier 503, and output from the column offset detection circuit 108 via a signal line 505.

Further, a vertical detection window signal 506 (VWDET) for designating the vertical detection region of the column offset, and a horizontal detection window signal 507 (HWIN) for designating the horizontal detection region are supplied from the window circuit 109 to the respective units of the column offset detection circuit 108. Also, a mode reset signal 508 (RESM) for designating reload of an initial value to the line memory 504 is supplied from the TG 105 to the respective units of the column offset detection circuit 108.

The operation of the column offset detection circuit 108 will be explained.

The image sensing signal Xn is input to a cyclic integration circuit formed from the multiplier 501, multiplier 503, adder 502, and line memory 504, and undergoes cyclic calculation between vertical data. A cyclic calculation value Yn having a value for each horizontal pixel (individually for each column) is sequentially updated and stored in the line memory 504.

The calculation equation of the cyclic calculation value Yn is given by:

cyclic coefficients: K1, K2 (=1−K1)

cyclic calculation value: Yn←K1·Xn+K2·Yn−1 (1)

where the suffix n is the cyclic calculation count which is updated for every line.

In the example of FIG. 6, K1=1/64 and K2=63/64 are set as cyclic coefficients. Calculation based on the weighted average is cyclically repeated for the image sensing signal Xn at a ratio of 1:63.

The line memory 504 can hold pixel data of one horizontal data represented by the horizontal detection window signal HWIN.

In synchronism with the VD signal for starting the first frame in moving image shooting, the system controller 110 instructs the line memory 504 to reload an initial value using the mode reset signal 508 (RESM) via the TG 105.

After that, the cyclic integration circuit sequentially performs these operations for each horizontal pixel in a column offset detection region indicated by the vertical detection window signal VWDET and horizontal detection window signal HWIN.

In the period of the vertical detection window signal VWDET, a cyclic calculation value stored and held in the line memory 504 after a plurality of cyclic calculation operations is read out as detected column offset correction data to the column offset removal circuit 111 to remove the column offset.

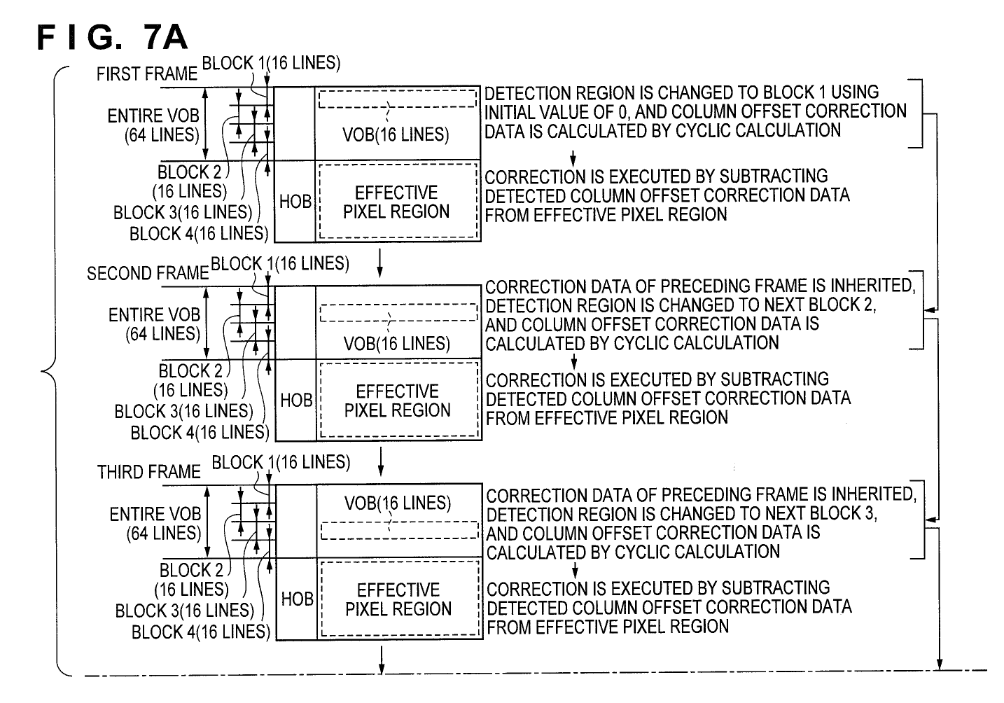

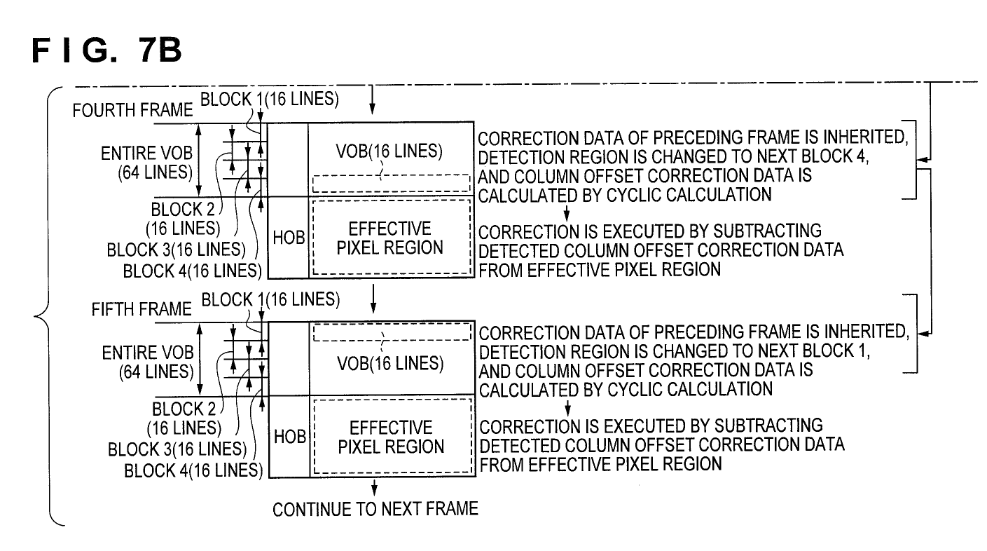

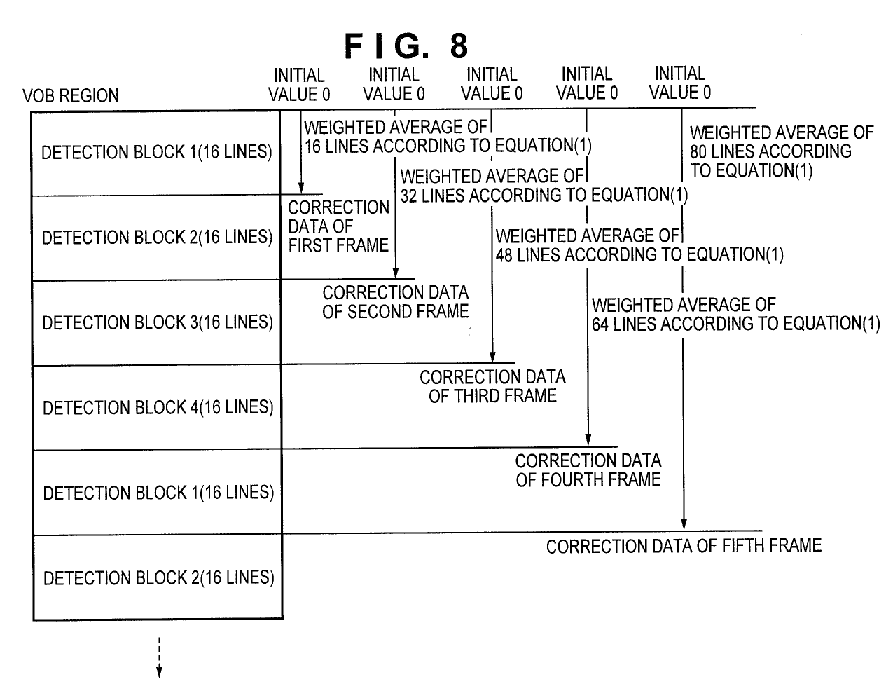

FIGS. 7A and 7B show processing of detecting and correcting column offsets from respective frame images successively read out in moving image shooting. FIG. 8 shows a state in which column offset correction data are calculated from respective frame images.

The VOB region is formed from a total of 64 lines. The VOB region is divided into four detection blocks each of 16 lines in the vertical direction.

At the start of moving image shooting, a column offset is detected from the VOB region of the first frame using an initial value of 0 in cyclic calculation equation (1). The result is subtracted from the image sensing signal of the effective pixel region, removing the column offset. The VOB region of the first frame is the region of block 1 designated by the first 16 lines of the VOB region.

The second frame inherits column offset data of the first frame as a cyclic calculation value, and a column offset is detected from the VOB region of the second frame. The result is subtracted from the image sensing signal of the effective pixel region, removing the column offset. The VOB region of the second frame is the region of block 2 designated by the next 16 lines succeeding the VOB region of the first frame.

The third frame further inherits column offset data of the second frame as a cyclic calculation value, and a column offset is detected from the VOB region of the third frame. The result is subtracted from the image sensing signal of the effective pixel region, removing the column offset. The VOB region of the third frame is the region of block 3 designated by the next 16 lines succeeding the VOB region of the second frame.

The fourth frame further inherits column offset data of the third frame as a cyclic calculation value, and a column offset is detected from the VOB region of the fourth frame. The result is subtracted from the image sensing signal of the effective pixel region, removing the column offset. The VOB region of the fourth frame is the region of block 4 designated by the final 16 lines succeeding the VOB region of the third frame. In the fourth frame, column offset data have been read out from the entire VOB region.

The fifth frame further inherits column offset data of the fourth frame as a cyclic calculation value, and a column offset is detected from the VOB region of the fifth frame. The result is subtracted from the image sensing signal of the effective pixel region, removing the column offset. The VOB region of the fifth frame returns again to the region of block 1 designated by the first 16 lines of the VOB region, and is the same as the VOB region of the first frame. Subsequently, readout from the entire VOB region is repeated every four frames.

As described above, pixel defect noise and RTS noise are superimposed in the VOB region serving as the column offset detection region, and may become error factors which lessen the column offset detection precision.

Also, pixel source followers each having a high RTS noise occurrence frequency are localized in the column offset detection region, and the error amount affected by RTS noise greatly differs between detection blocks.

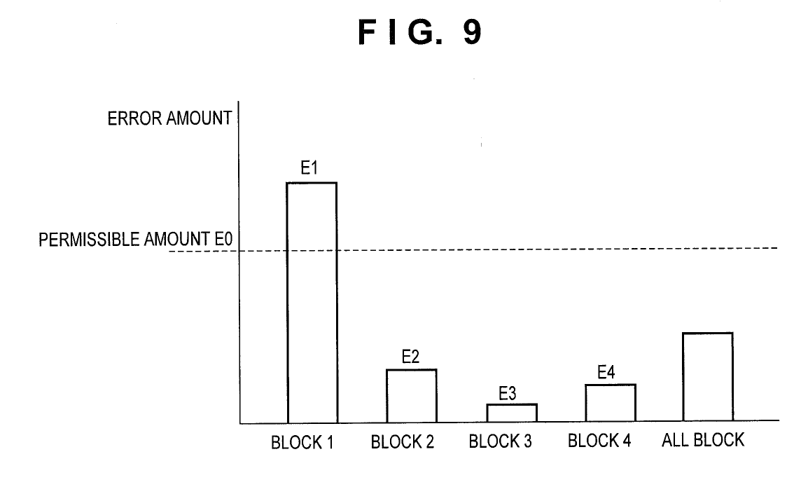

FIG. 9 schematically shows the relationship between an error amount in each detection block and an error amount in all the detection blocks with respect to the error amount by RTS noise generated on a specific pixel column.

In FIG. 9, the error amount in each detection block is an error amount based on the weighted average of 16 lines within the detection block upon repetitive readout from only a single detection block for each frame.

The error amount in all detection blocks is an error amount based on the weighted average of 64 lines in the entire detection region upon repetitive readout from all detection blocks in every four frames.

In the example of FIG. 9, RTS noise occurs at high frequency locally in 16 lines of detection block 1. An error amount based on the weighted average of only 16 lines of detection block 1 exceeds a permissible level at which the error amount affects an image.

In terms of the image sensor manufacturing process, it is very difficult to suppress the RTS noise occurrence frequency at low level in all pixels in the entire VOB region. In addition, the RTS noise occurrence frequency is localized, and a detection block in which the error amount exceeds the permissible level differs between image sensors because of an individual difference.

However, regardless of how RTS noise is localized, it is possible to manufacture an image sensor in which the RTS noise occurrence frequency is suppressed to a predetermined level or lower when it is averaged in the entire VOB region.

FIG. 9 shows a state in which an error amount based on the weighted average of 64 lines of all detection blocks including detection block 1 is reduced to a permissible level because the RTS noise occurrence frequency is low in detection blocks 2, 3, and 4 in the image sensor.

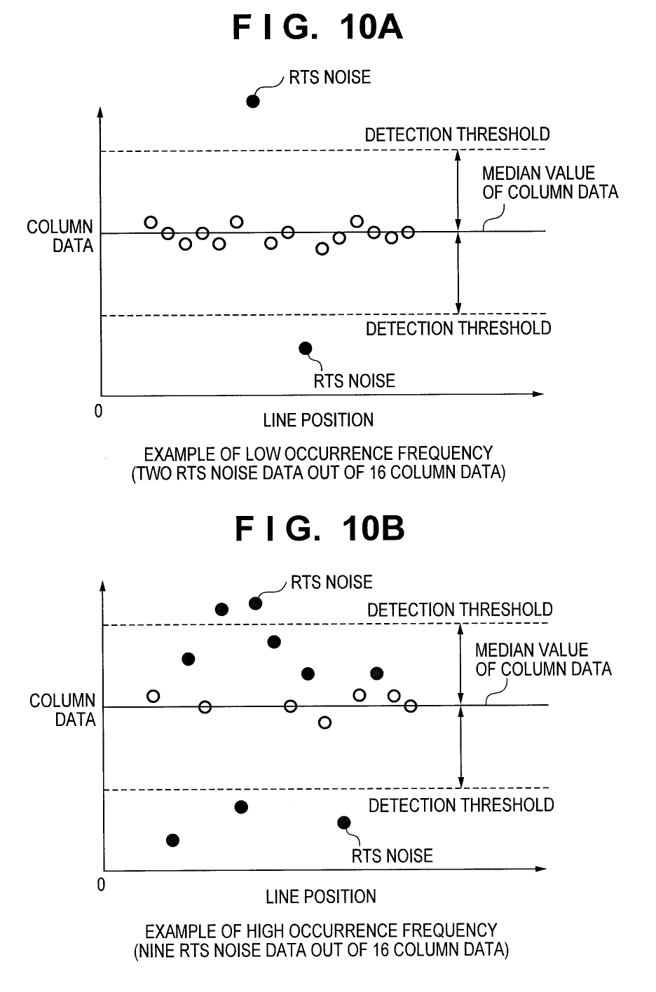

FIGS. 10A and 10B show the data distributions of pixel signals on the same column in the respective detection blocks of the VOB region. A method of detecting the RTS noise occurrence frequency will be exemplified with reference to FIGS. 10A and 10B.

In this example, predetermined thresholds are set for the median value of column data. Data exceeding these thresholds are regarded as RTS noise, and the generated data are counted. A larger count is determined as a higher RTS noise occurrence frequency. The thus-obtained detection value of the RTS noise occurrence frequency and the error amount obtained by the weighted average have a strong correlation.

In the image sensor manufacturing process, it is very difficult to suppress the RTS noise occurrence frequency at low level in all pixels in the entire VOB region. Also, the RTS noise occurrence frequency is localized, and a detection block in which the error amount exceeds the permissible level differs between image sensors owing to an individual difference.

For this reason, the RTS noise occurrence frequency is detected in advance for each detection block in each image sensor, and the detection result is stored in an image sensing apparatus in which the image sensor is mounted. This adjustment procedure may be performed during the process of the image sensor manufacturing line or by setting an adjustment mode or the like in the image sensing apparatus.

By changing the detection region for each frame, like the embodiment, the error amount based on the weighted average using the entire detection region can be reduced to be equal to or lower than the permissible level.

In the embodiment, data are read out from 64 lines of the entire detection region in four frames. However, the detection region should be appropriately expanded based on the RTS noise occurrence frequency of an image sensor, in order to obtain a satisfactory noise reduction effect.

The embodiment can reduce the influence of RTS noise without increasing the number of detection lines per frame. The embodiment neither decreases the moving image frame rate nor requires an increase in readout operation speed which leads to large power consumption.

In the description of the embodiment, VOB pixels are assigned to the column offset detection region.

However, according to the gist of the present invention, the same effects can also be obtained even by assigning, as a detection region, so-called dummy pixels in which readout is performed without electrically connecting a photodiode to a pixel source follower.

In fact, dummy pixels are advantageous for detection of a column offset because they are free from pixel defect noise arising from the photodiode. In this case, the black level reference of an effective pixel can be obtained by the clamp operation of an HOB pixel.

The embodiment has exemplified weighted average cyclic calculation using K1=1/64 and K2=63/64 as cyclic coefficients in equation (1).

However, according to the present invention, for example, the weighted average can be cyclically calculated repetitively 16 times using K1=1/16 and K2=1 in equation (1). In this case, the average value is calculated for each detection block and inherited as a cyclic calculation value to the next frame.

### Second Embodiment

In the first embodiment, a detection region of 16 lines is assigned to each frame. However, changing the detection region for every frame can further decrease the number of detection lines per frame and increase the moving image frame rate. The second embodiment to be described below implements this.

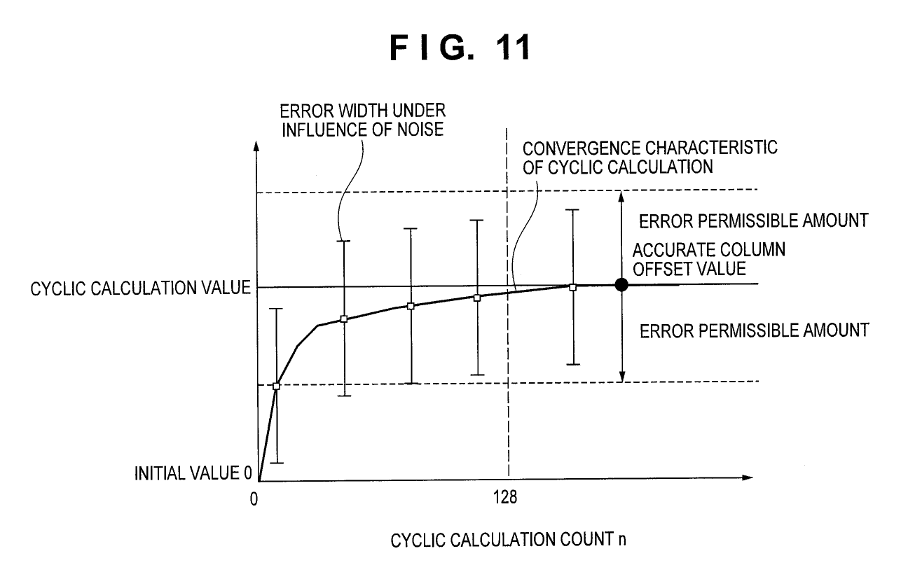

FIG. 11 shows convergence of the cyclic calculation value.

As for cyclic calculation equation (1), for example, if the cyclic coefficient K is (1/64), a weighted average is calculated using (1/64) of input data Xn as a cyclic calculation value in one cyclic calculation. By repeating this calculation 128 times, the calculation value can be almost converged.

In the second embodiment, the VOB detection line count of one frame is set to 16, and 16 cyclic calculation operations can be performed in each frame. Thus, the calculation can be almost converged in the first eight frames to detect an accurate column offset.

When the moving image frame rate is 30 [frames/sec], the time taken for eight frames is 0.27 (=8/30) sec. This means that 0.27 sec is taken until a column offset is accurately detected and corrected to remove a vertical stripe from a moving image after the start of rendering a moving image. It is not preferable for the moving image quality to prolong the convergence time of cyclic calculation further more.

The maximum value of the column offset is expected to be several mV to several ten mV in an output from an image sensor. The upper limit value of the cyclic coefficient K1 that satisfies the convergence time permissible to detect and correct such a column offset is K1=1/64 (K2=63/64).

A value obtained by multiplying the RTS noise occurrence frequency at one portion by the cyclic coefficient K1 (1/64) serves as an error of the cyclic calculation value.

If the cyclic coefficient K1 is increased to (1/32) or the like, the convergence time of cyclic calculation shortens, but an error by RTS noise increases. For this reason, the cyclic coefficient K1 cannot be simply increased.

Decreasing the number of detection lines per frame can further increase the moving image frame rate. However, if the number of detection lines per frame is halved from 16 lines to eight lines, the convergence time of cyclic calculation is prolonged to 0.54 (=16/30) sec which is equivalent to as double as 16 frames.

Decreasing the number of detection lines per frame requires a measure to avoid the above-described problem in which the convergence time of cyclic calculation is prolonged.

For this purpose, the second embodiment adds the following operation to the first embodiment. More specifically, cyclic calculation is converged within a short period prior to readout of the first frame image of a moving image, and then a column offset is detected. The detected column offset is used as the initial value of the column offset detection value, and the column offset is corrected at high precision from the first frame of the moving image.

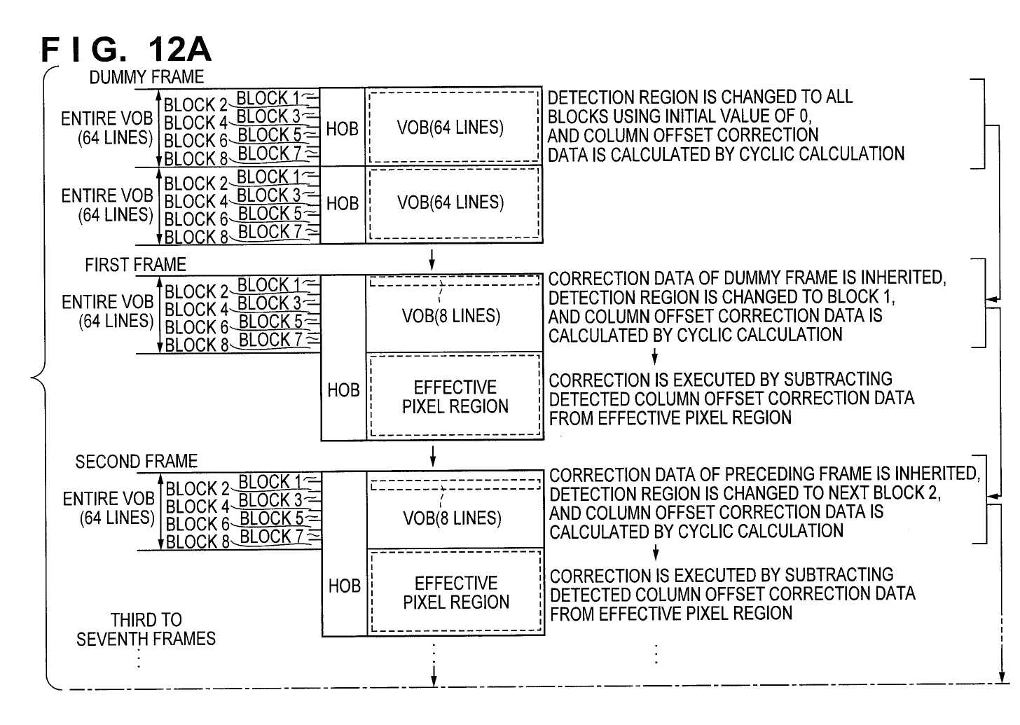

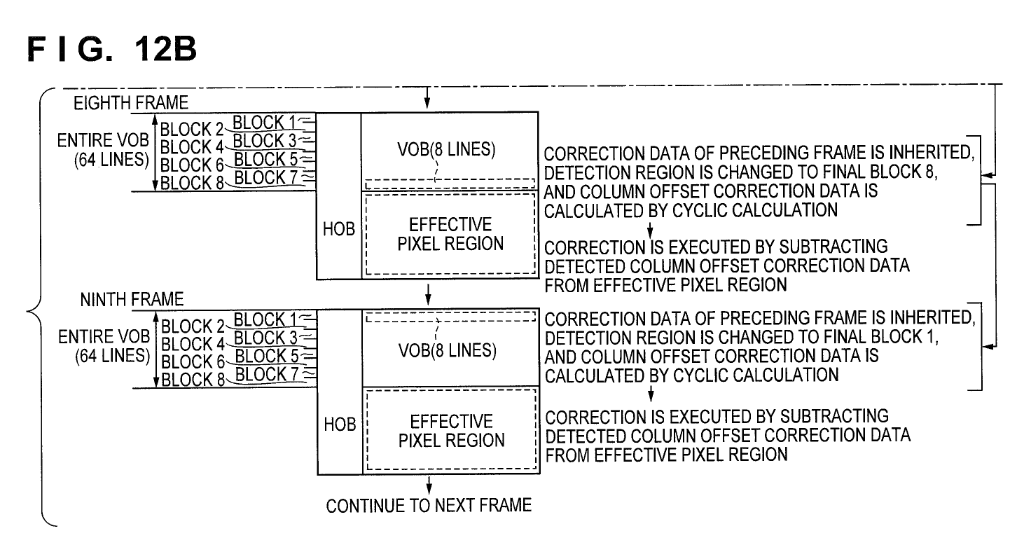

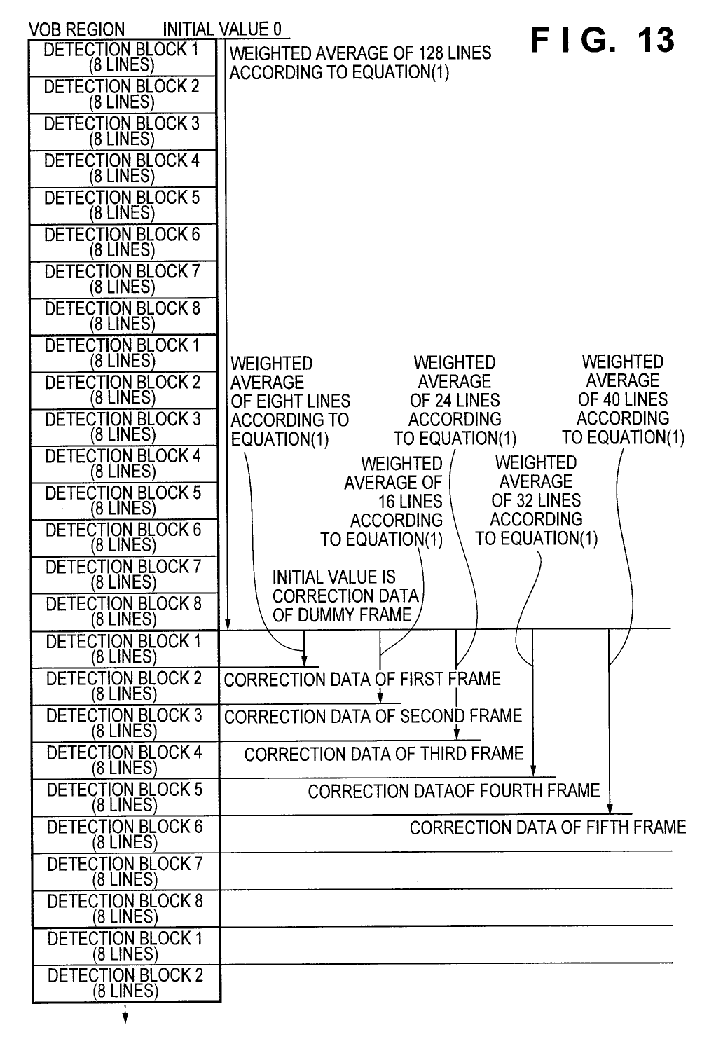

FIGS. 12A and 12B show processing of detecting and correcting column offsets from respective frame images successively read out in moving image shooting. FIG. 13 shows a state in which column offsets are detected from respective frame images to calculate correction data.

The VOB region is formed from a total of 64 lines. The VOB region is divided into eight detection blocks each of eight lines in the vertical direction.

A dummy frame is set first prior to readout of a moving image, and a column offset is detected from the VOB region of the dummy frame using an initial value of 0 in cyclic calculation. The VOB region of the dummy frame is the entire VOB region designated by 64 lines. The dummy frame is formed from only the VOB region, and no pixel signal is read out from the effective pixel region in order to shift the operation to the first frame of the moving image within a short period.

Further, in the dummy frame, data are read out a total of twice from the VOB region designated by 64 lines in order to converge cyclic calculation with the cyclic coefficient K (1/64) and detect an accurate column offset.

The readout time of 128 lines of the VOB region in the dummy frame is much shorter than the readout time ( 1/30 sec) of one frame of a normal moving image. This time loss till the start of rendering a moving image does not pose a problem.

Column offset data of the dummy frame is inherited as the initial value of the cyclic calculation value, and a column offset is detected from the VOB region of the first frame. The result is subtracted from the image sensing signal of the effective pixel region, removing the column offset. The VOB region of the first frame is the region of block 1 designated by the first eight lines in the VOB region.

The second frame inherits column offset data of the first frame as a cyclic calculation value, and a column offset is detected from the VOB region of the second frame. The result is subtracted from the image sensing signal of the effective pixel region, removing the column offset. The VOB region of the second frame is the region of block 2 designated by the next eight lines succeeding the VOB region of the first frame.

Similarly, a subsequent frame further inherits column offset data of a preceding frame as a cyclic calculation value, and a column offset is detected from the VOB region of this frame. The result is subtracted from the image sensing signal of the effective pixel region, removing the column offset. The VOB region of the frame is a block region designated by the next eight lines succeeding the VOB region of a preceding frame. In this way, the readout operation is executed sequentially from the third to seventh frames.

The eighth frame further inherits column offset data of the seventh frame as a cyclic calculation value, and a column offset is detected from the VOB region of the seventh frame. The result is subtracted from the image sensing signal of the effective pixel region, removing the column offset. The VOB region of the eighth frame is the region of block 8 designated by the final eight lines succeeding the VOB region of the seventh frame. In the eighth frame, column offset data have been read out from the entire VOB region.

The ninth frame further inherits column offset data of the eighth frame as a cyclic calculation value, and a column offset is detected from the VOB region of the ninth frame. The result is subtracted from the image sensing signal of the effective pixel region, removing the column offset. The VOB region of the ninth frame returns again to the region of block 1 designated by the first eight lines of the VOB region, and is the same as the VOB region of the first frame. Subsequently, the readout process from the entire VOB region is repeated in every eight frames.

In the second embodiment, a dummy frame is inserted prior to readout of the first frame image of a moving image, solving the problem of the convergence time of cyclic calculation.

In addition, changing the number of detection lines per frame to eight can increase the moving image frame rate, compared to the first embodiment.

### Third Embodiment

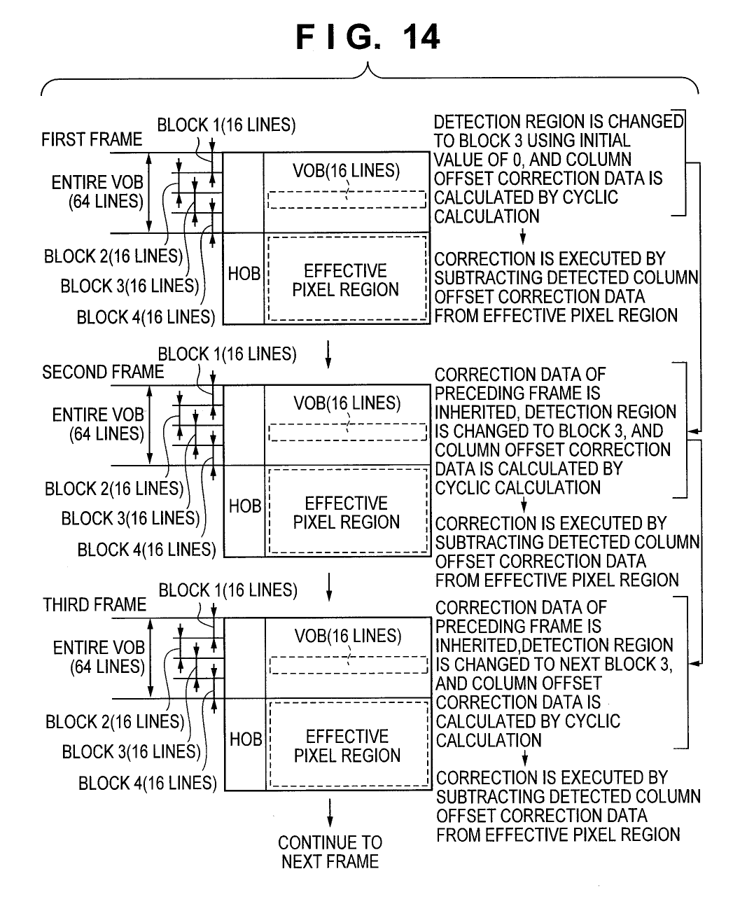

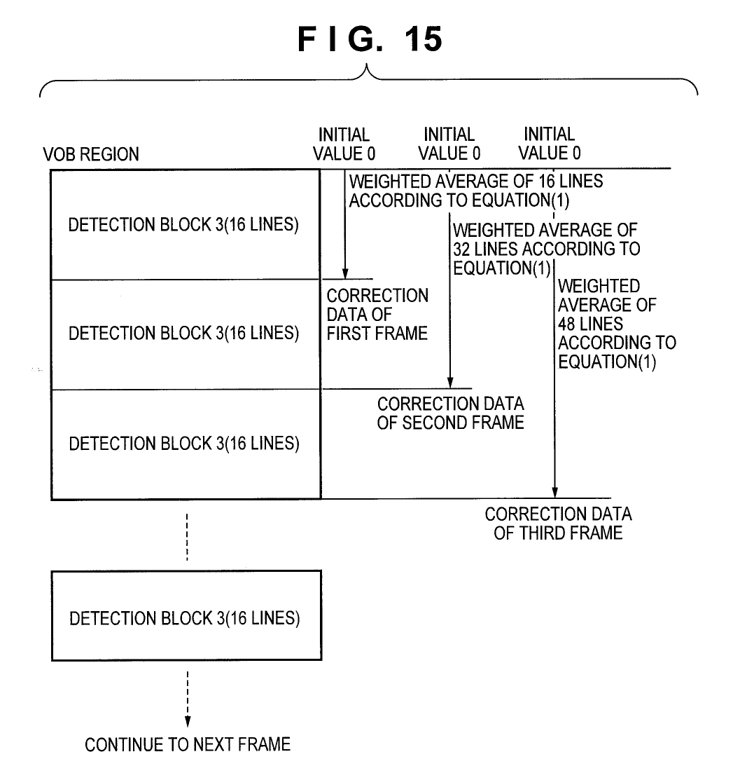

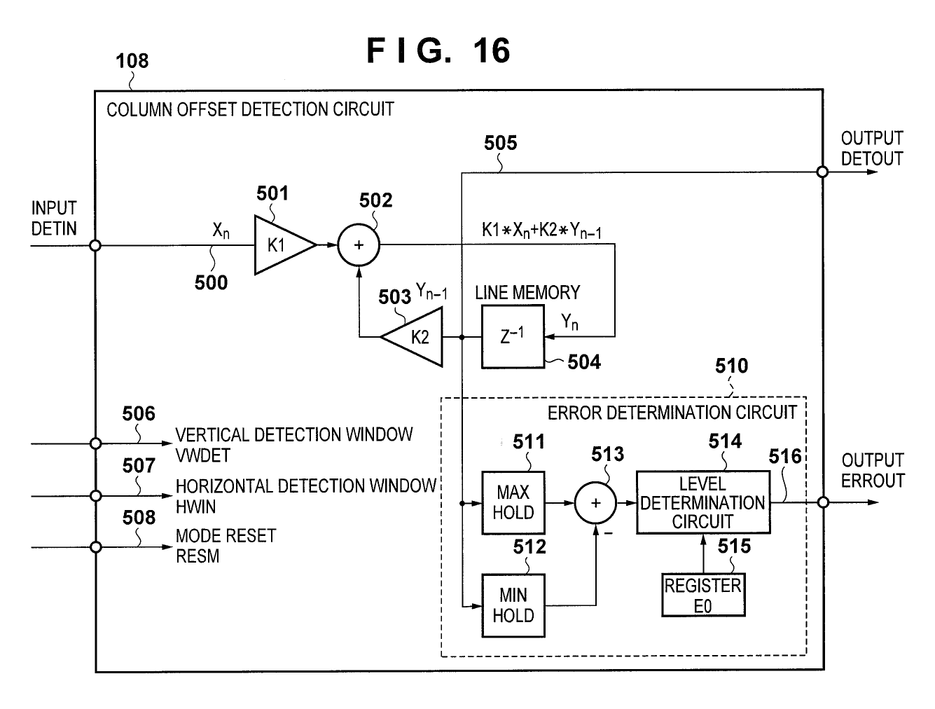

The third embodiment will be described with reference to FIGS. 14 and 15.

FIG. 14 shows processing of detecting and correcting column offsets from respective frames successively read out in moving image shooting. FIG. 15 shows a state in which column offsets are detected from respective frames to calculate correction data.

Here, a case in which the RTS noise occurrence frequency of an image element has been detected in advance before moving image shooting, the error amount of detection block 1 is extremely large, and that of detection block 3 is smallest, as shown in FIG. 9, will be exemplified.

At the start of a moving image operation, detection block 3 considered to have a smallest error amount obtained by the weighted average based on the detection results of respective blocks regarding the RTS noise occurrence frequency of the image sensor that are stored in the image sensing apparatus is designated as the VOB detection region.

As a simplest method of designating detection block 3 and detecting a column offset, when the image sensor is formed from a CMOS sensor, the remaining block regions are skipped and data is read out only from detection block 3 under the control of a vertical scanning circuit inside the sensor.

However, even when the image sensor is formed from a CCD sensor incapable of skip, the skip can be achieved by changing the cyclic coefficients in equation (1) to K1=0 and K2=1 to change the ratio of the weighted average in a column offset detection circuit 108 in readout from another block region. In this case, the weighting ratio of regions other than detection block 3 is set to 0, and the weighted average calculation result becomes equal to the result obtained upon skipping other regions.

A column offset is detected from detection block 3 designated as the VOB region of the first frame at an initial value of 0 in cyclic calculation. The result is subtracted from the image sensing signal of the effective pixel region, removing the column offset.

The second frame inherits column offset data of the first frame as a cyclic calculation value, and a column offset is detected from detection block 3 also designated as the VOB region. The result is subtracted from the image sensing signal of the effective pixel region, removing the column offset.

Similarly, the third frame inherits column offset data of the preceding frame as a cyclic calculation value, and a column offset is detected from detection block 3 also designated as the VOB region. The result is subtracted from the image sensing signal of the effective pixel region, removing the column offset.

Subsequently, detection block 3 is designated as the VOB region in respective frames, and readout is repeated.

In this manner, the detection region is divided to select a detection block based on the detection results of the RTS noise occurrence frequency in respective divided detection blocks. Weighted average cyclic calculation in a region having a low noise occurrence frequency while avoiding a region having a high noise occurrence frequency can suppress the influence of RTS noise and reduce the error amount generated by RTS noise to be equal to or smaller than a permissible level.

In the third embodiment, the detection region and the number of divided blocks should also be expanded appropriately based on the RTS noise occurrence frequency of an image sensor, in order to obtain a satisfactory noise reduction effect.

In the third embodiment, the same effects can be obtained by assigning, as a detection region, so-called dummy pixels in which readout is performed without electrically connecting a photodiode to a pixel source follower.

The above-described weighted average operation is also used in the fourth and fifth embodiments to be described below.

### Fourth Embodiment

As described above, regions each having a high RTS noise occurrence frequency are localized in the VOB detection region. However, these local portions often change depending on the temperature characteristic of a pixel source follower element and a change over time.

The fourth embodiment will describe a method capable of coping in real time with even an environment such as temperature or a change over time by installing a procedure to calculate an error amount generated by RTS noise during image sensing for each detection block and adopt a given detection block within a predetermined period.

A configuration and operation different from those in the third embodiment will be mainly explained.

The basic configuration of an image sensing apparatus is the same as that in the third embodiment except that a means for calculating an error amount generated by RTS noise is added to the image sensing apparatus.

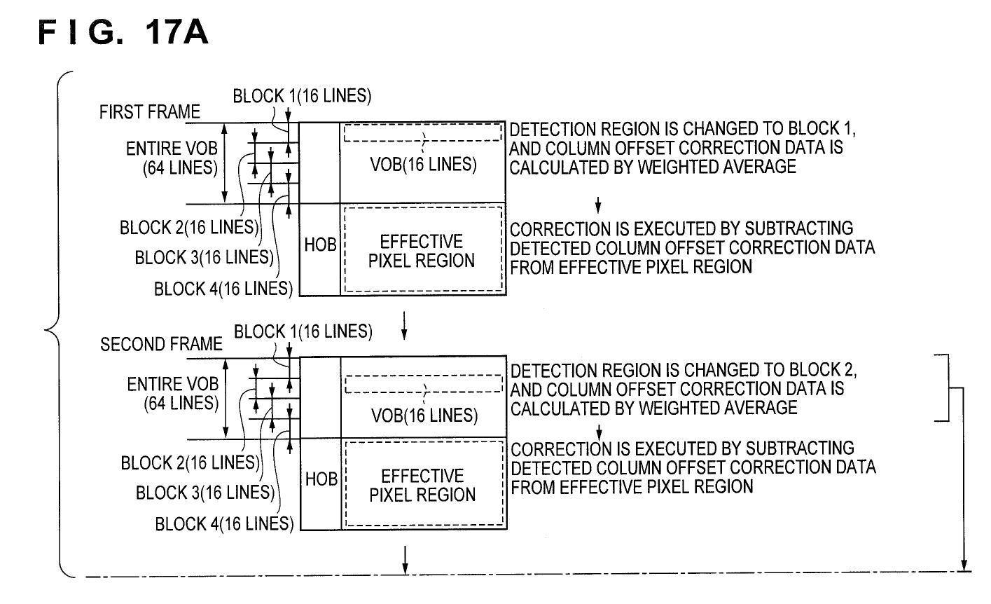

FIG. 16 shows the internal configuration of a column offset detection circuit 108 to which a circuit configuration for calculating an error amount generated by RTS noise is added. The portion newly added to the configuration of FIG. 6 is an error determination circuit 510 surrounded by a broken frame.

The error determination circuit 510 includes a maximum value detection circuit 511 which detects a maximum value from column offset correction data of each column serving as an output from a line memory 504, and a minimum value detection circuit 512 which similarly detects a minimum value from column offset correction data of each column.

Further, the error determination circuit 510 includes a subtracter 513 which subtracts an output of the minimum value detection circuit 512 from an output of the maximum value detection circuit 511, and a level determination circuit 514 which receives an output value from the subtracter 513, determines whether the output value falls within a predetermined value, and outputs the determination result. Further, the level determination circuit 514 is connected to a register capable of setting a register value E0 by a system controller 110.

An output from the level determination circuit 514 is supplied as an error determination output result to the system controller 110 via a signal line 516.

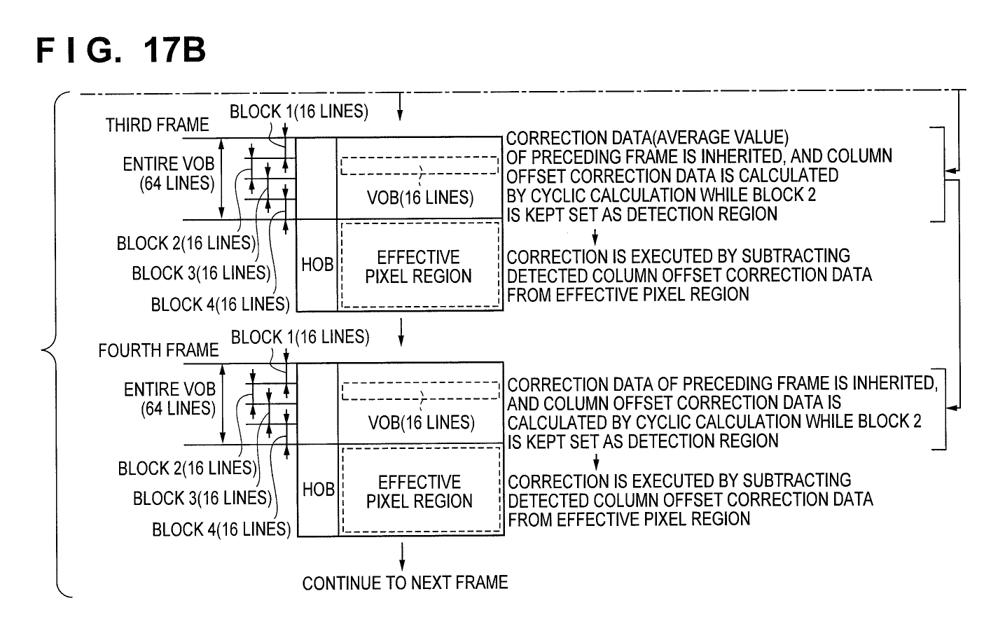

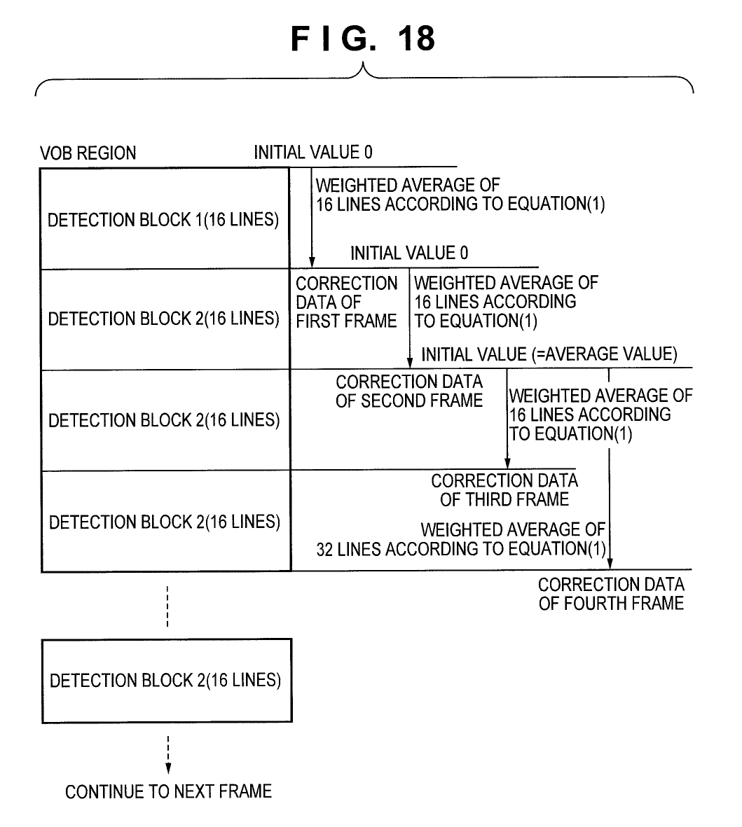

FIGS. 17A and 17B show processing of detecting and correcting column offsets from respective frame images successively read out in moving image shooting. FIG. 18 shows a state in which column offsets are detected from respective frames to calculate correction data.

Similar to the third embodiment, a total of 64 lines are set in the VOB region. The VOB region is divided into four detection blocks each of 16 lines in the vertical direction.

As for the RTS noise occurrence frequency of an image sensor, the operation will be explained by exemplifying the use of an image sensor having the same characteristics as those in FIG. 9.

That is, a case in which the error amount of detection block 1 is extremely large and exceeds a permissible amount, those of detection blocks 2 to 4 fall within the permissible amount, and that of detection block 3 is smallest will be described.

At the start of moving image shooting, detection block 1 of 16 lines starting from the first line of the VOB region is designated as the detection region of the first frame.

The cyclic coefficients in equation (1) are set to K1=1/16 and K2=1. Then, the weighted average is cyclically calculated repetitively 16 times using these cyclic coefficients, calculating the average value of 16 lines for each column within detection block 1.

The calculated average value for each column is read out in the period of the vertical correction window signal VWCOL. The result is subtracted from the image sensing signal of the effective pixel region, removing the column offset.

The average value for each column that has been read out in the period of the vertical correction window signal VWCOL is also supplied to the error determination circuit 510 shown in FIG. 16. The maximum value detection circuit 511 and minimum value detection circuit 512 detect and hold maximum and minimum values, respectively. The difference value between the maximum and minimum values serves as a column offset maximum value, and the level determination circuit 514 compares the column offset maximum value with the register value E0. If the column offset maximum value is larger than the register value E0, an error is output as the output 516 from the level determination circuit 514.

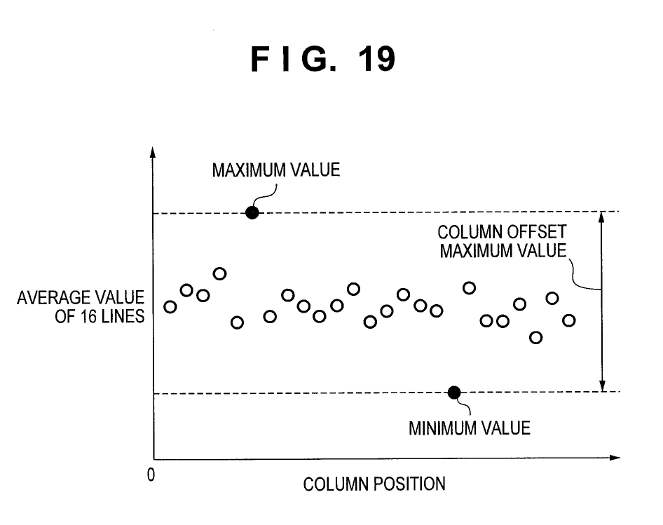

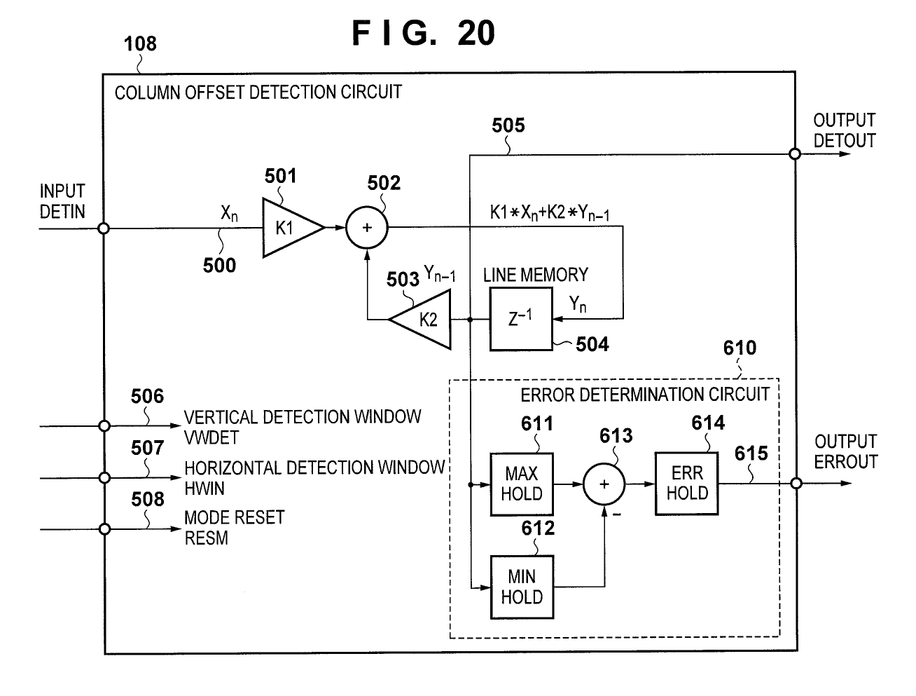

FIG. 19 shows an average value for each column and a column offset maximum value.

The register value E0 is set to a predetermined value over a column offset upper limit value defined by an image sensor. In general, the register value E0 is a value corresponding to several mV to several ten mV in terms of an output from the image sensor. An error is output as the determination result of a column offset maximum value exceeding the column offset upper limit value.

In this case, RTS noise is localized in detection block 1. Thus, the error amount by RTS noise increases, and an error is output as the determination result.

The error determination result is transferred to the system controller 110 and stored.

In the second frame, the system controller 110 designates, as the VOB region, block 2 of the next 16 lines succeeding the VOB region of the first frame in accordance with the error determination result, updating the detection block.

Thereafter, the column offset detection circuit 108 sets the cyclic coefficients in equation (1) again to K1=1/16 and K2=1, and an initial value of 0 in cyclic calculation in exactly the same way as for the first frame.

The weighted average is cyclically calculated repetitively 16 times using these cyclic coefficients, calculating the average value of 16 lines for each column within detection block 2.

The calculated average value for each column is read out in the period of the vertical correction window signal VWCOL. The result is subtracted from the image sensing signal of the effective pixel region, removing the column offset.

The error determination circuit 510 calculates a column offset maximum value using the average value for each column that has been read out in the period of the vertical correction window signal VWCOL. The level determination circuit 514 compares the column offset maximum value with the register value E0.

At this time, RTS noise is not localized in detection block 2, unlike the first frame. Hence, the error amount by RTS noise falls within the permissible value, and a non-error is output as the determination result.

The non-error determination result is transferred to the system controller 110 and stored.

In the third frame, the system controller 110 designates, as the VOB region, the same detection block 2 as that of the second frame in accordance with the non-error determination result, and does not update the detection block.

In the third and succeeding frames, the column offset detection circuit 108 does not perform error determination because of the non-error determination result. The non-error determination result which has been transferred to the system controller 110 and stored is not updated.

Cyclic calculation equation (1) inherits, as an initial value, column offset data of the second frame serving as an immediately preceding frame, that is, the average value of 16 lines calculated for each line in detection block 2.

Further, the cyclic coefficients in equation (1) are set to K1=1/64 and K2=63/64. The weighted average is cyclically calculated repetitively 16 times using these cyclic coefficients, calculating the average value of 16 lines for each column within detection block 2.

The calculated average value for each column is read out in the period of the vertical correction window signal VWCOL. The result is subtracted from the image sensing signal of the effective pixel region, removing the column offset.

In the fourth frame, the system controller 110 designates, as the VOB region, the same detection block 2 as that of the second frame in accordance with the previous non-error determination result, and the detection block is not updated.

Cyclic calculation equation (1) inherits column offset data of the third frame serving as an immediately preceding frame, that is, the average value of 16 lines calculated for each column in detection block 2.

Similar to the third frame, the cyclic coefficients are set to K1=1/64 and K2=63/64. The weighted average is cyclically calculated repetitively 16 times using these cyclic coefficients, calculating the average value of 16 lines of the immediately preceding frame and 16 lines of the fourth frame, that is, 32 lines.

The calculated average value for each column is read out in the period of the vertical correction window signal VWCOL. The result is subtracted from the image sensing signal of the effective pixel region, removing the column offset.

Subsequently, detection block 2 is designated as the VOB region in each frame, and the readout process is repeated similarly.

In this fashion, the error amount by RTS noise is detected for each detection block in the first several frames in moving image shooting. Readout is performed while changing the detection block until the error amount by RTS noise reaches the permissible level, thereby selecting a detection block. In subsequent frames, the error amount by RTS noise can be reduced to the permissible level or lower.

### Fifth Embodiment

In the fourth embodiment, detection block 2 is selected by performing readout while changing the detection block until the error amount by RTS noise reaches the permissible level. However, as for the RTS noise occurrence frequency of an image sensor, in an image sensor having the same characteristics as those in FIG. 9, detection block 3 has a smallest error amount and is considered to be an optimum detection block among all detection blocks.

The fifth embodiment will describe a method of detecting a column offset at highest precision by installing a procedure to calculate an error amount generated by RTS noise in each detection block during an image sensing operation and adopt a detection block having a minimum error amount.

The fifth embodiment is different from the fourth embodiment in the level determination circuit configuration in a column offset detection circuit 108 and control by a system controller 110.

The level determination circuit configuration in the column offset detection circuit and the control method by the system controller 110, which are different from the fourth embodiment, will be explained.

FIG. 20 shows the internal configuration of the column offset detection circuit 108 to which a circuit configuration for calculating an error amount generated by RTS noise is added. The portion newly added to the circuit configuration of FIG. 6 is an error determination circuit 610 surrounded by a broken frame.

The error determination circuit 610 includes a maximum value detection circuit 611 and minimum value detection circuit 612 which detect maximum and minimum values from column offset correction data of each column serving as an output from a line memory 504, respectively.

Further, the error determination circuit 610 includes a subtracter 613 which subtracts an output of the minimum value detection circuit 612 from an output of the maximum value detection circuit 611, and an error amount holding circuit 614 which receives an output value from the subtracter 613 and holds it for a predetermined period. An output 615 from the error amount holding circuit 614 is supplied as an error amount output result to the system controller 110.

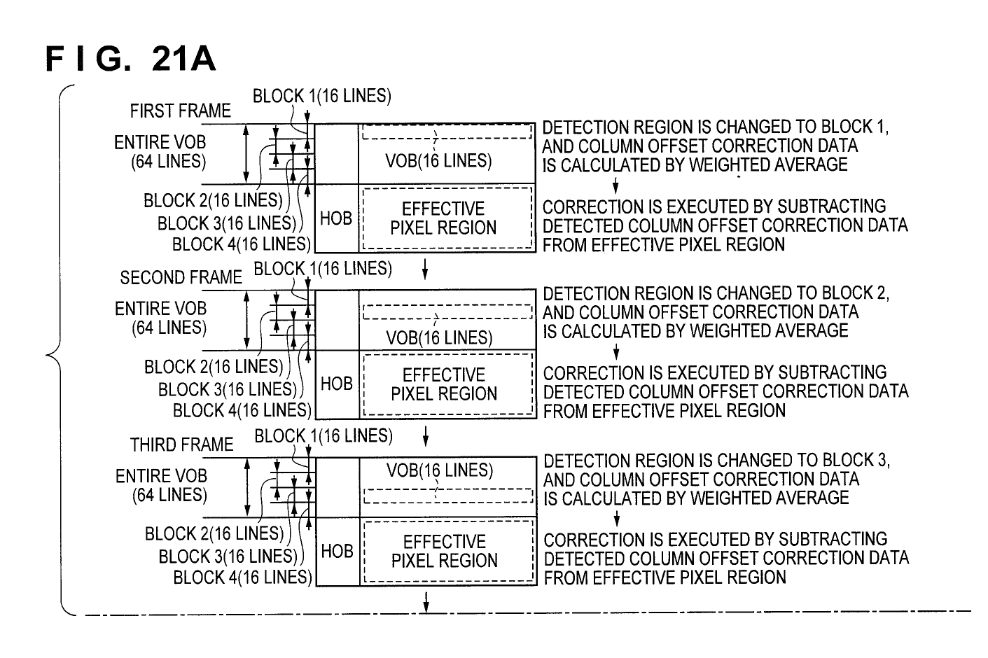

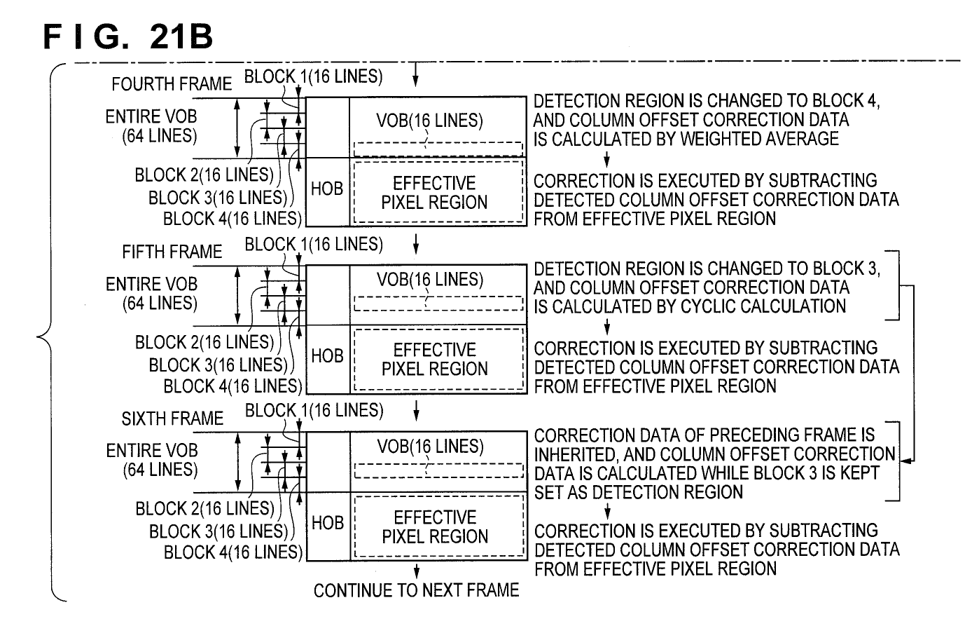

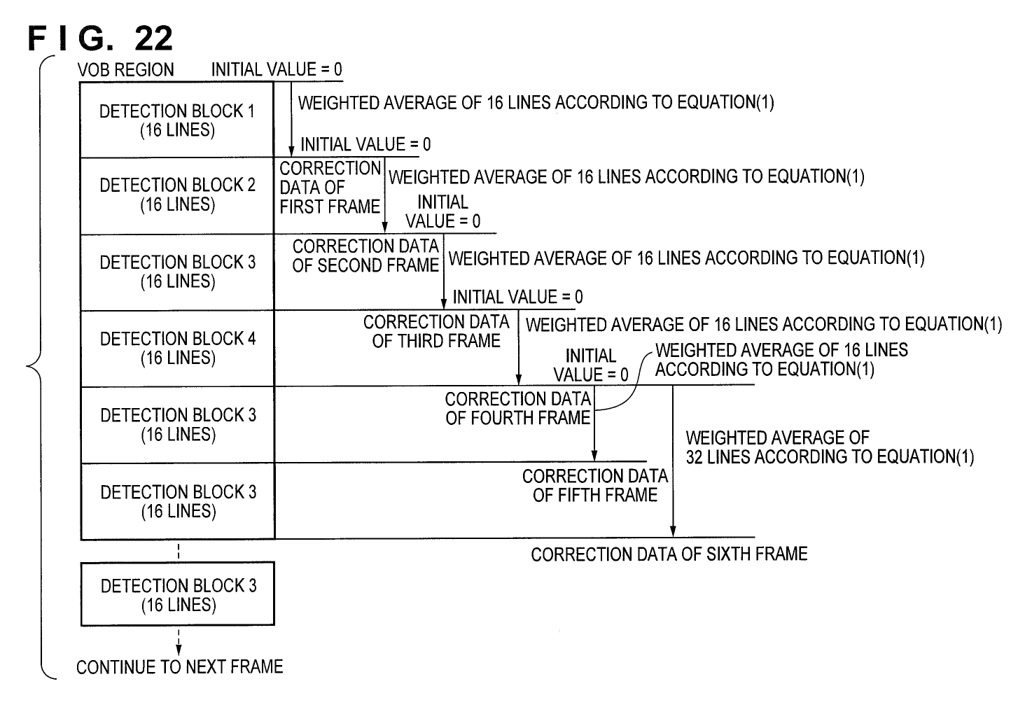

FIGS. 21A and 21B show processing of detecting and correcting column offsets from respective frame images successively read out in moving image shooting. FIG. 22 shows a state in which column offsets are detected from respective frames to calculate correction data.

Similar to the above-described embodiments, a total of 64 lines are set in the VOB region. The VOB region is divided into four detection blocks each of 16 lines in the vertical direction.

The RTS noise occurrence frequency of an image sensor will be explained by exemplifying the use of an image sensor having the same characteristics as those in FIG. 9. That is, a case in which the error amount of detection block 1 is extremely large and exceeds a permissible amount, those of detection blocks 2 to 4 fall within the permissible amount, and that of detection block 3 is smallest will be described.

At the start of moving image shooting, detection block 1 of 16 lines starting from the first line of the VOB region is designated as the detection region of the first frame.

In the column offset detection circuit 108, the initial value of equation (1) is set to 0, and the cyclic coefficients are set to K1=1/16 and K2=1. Then, the weighted average is cyclically calculated repetitively 16 times using these cyclic coefficients, calculating the average value of 16 lines for each column within detection block 1.

The calculated average value for each column is read out in the period of the vertical correction window signal VWCOL. The result is subtracted from the image sensing signal of the effective pixel region, removing the column offset.

The average value for each column that has been read out in the period of the vertical correction window signal VWCOL is also supplied to the error determination circuit 610 shown in FIG. 20. The maximum value detection circuit 611 and minimum value detection circuit 612 detect and hold maximum and minimum values, respectively. The difference value between the maximum and minimum values is held as a column offset maximum value in the error amount holding circuit 614, and supplied as an error amount output result to the system controller 110.

In this case, RTS noise is localized in detection block 1. Thus, an error amount E1 by RTS noise that exceeds a permissible amount E0 is transferred to the system controller 110 and stored in the internal storage area of the system controller 110.

In the second frame, the system controller 110 designates, as the VOB region, block 2 of the next 16 lines succeeding the VOB region of the first frame, updating the detection block.

After that, the column offset detection circuit 108 sets the cyclic coefficients in equation (1) again to K1=1/16 and K2=1, and an initial value of 0 in cyclic calculation in exactly the same way as for the first frame.

The weighted average is cyclically calculated repetitively 16 times using these cyclic coefficients, calculating the average value of 16 lines for each column within detection block 2.

The calculated average value for each column is read out in the period of the vertical correction window signal VWCOL. The result is subtracted from the image sensing signal of the effective pixel region, removing the column offset.

Based on the average value for each column that has been read out in the period of the vertical correction window signal VWCOL, an error amount E2 is transferred as the output result from the error determination circuit 610 to the system controller 110, and stored in the internal storage area of the system controller 110.

In the third frame, the system controller 110 designates, as the VOB region, block 3 of the next 16 lines succeeding the VOB region of the second frame, updating the detection block.

The column offset detection circuit 108 sets the cyclic coefficients in equation (1) again to K1=1/16 and K2=1, and an initial value of 0 in cyclic calculation in exactly the same way as for the second frame.

The weighted average is cyclically calculated repetitively 16 times using these cyclic coefficients, calculating the average value of 16 lines for each column within detection block 3.

The calculated average value for each column is read out in the period of the vertical correction window signal VWCOL. The result is subtracted from the image sensing signal of the effective pixel region, removing the column offset.

Based on the average value for each column that has been read out in the period of the vertical correction window signal VWCOL, an error amount E3 is transferred as the output result from the error determination circuit 610 to the system controller 110, and stored in the internal storage area of the system controller 110.

In the fourth frame, the system controller 110 designates, as the VOB region, block 4 of the next 16 lines succeeding the VOB region of the third frame, updating the detection block.

The column offset detection circuit 108 sets the cyclic coefficients in equation (1) again to K1=1/16 and K2=1, and an initial value of 0 in cyclic calculation in exactly the same way as for the third frame.

The weighted average is cyclically calculated repetitively 16 times using these cyclic coefficients, calculating the average value of 16 lines for each column within detection block 4.

The calculated average value for each column is read out in the period of the vertical correction window signal VWCOL. The result is subtracted from the image sensing signal of the effective pixel region, removing the column offset.

Based on the average value for each column that has been read out in the period of the vertical correction window signal VWCOL, an error amount E4 is transferred as the output result from the error determination circuit 610 to the system controller 110, and stored in the internal storage area of the system controller 110.

In the fifth frame, the system controller 110 designates, as the VOB region, detection block 3 having a smallest error amount among the error amounts E1, E2, E3, and E4 which have been stored in the storage area.

The column offset detection circuit 108 sets the cyclic coefficients in equation (1) again to K1=1/16 and K2=1, and an initial value of 0 in cyclic calculation.

The weighted average is cyclically calculated repetitively 16 times using these cyclic coefficients, calculating the average value of 16 lines for each column within detection block 3.

The calculated average value for each column is read out in the period of the vertical correction window signal VWCOL. The result is subtracted from the image sensing signal of the effective pixel region, removing the column offset.

In the fifth and subsequent frames, error amount detection by the error determination circuit 610 is not executed, unlike the preceding frames. The error amounts E1, E2, E3, and E4 which have been transferred to the system controller 110 and stored are not updated.

In the sixth frame, the system controller 110 designates block 3 as the VOB region, and does not update the detection block.

Then, cyclic calculation equation (1) inherits, as an initial value, column offset data of the fifth frame serving as an immediately preceding frame, that is, the average value of 16 lines calculated for each line in detection block 3.

At this time, the cyclic coefficients are set to K1=1/64 and K2=63/64. The weighted average is cyclically calculated repetitively 16 times using these cyclic coefficients, calculating the average value of 16 lines for each column within detection block 3.

The calculated average value for each column is read out in the period of the vertical correction window signal VWCOL. The result is subtracted from the image sensing signal of the effective pixel region, removing the column offset.

In subsequent frames, detection block 3 is steadily designated as the VOB region, and the same readout as that in the sixth frame is repeated.

In this manner, the error amount by RTS noise is detected for each detection block in the first several frames in moving image shooting. A detection block having a minimum error amount by RTS noise is selected. In subsequent frames, the error amount by RTS noise can be reduced to a minimum level.

### Sixth Embodiment

In the above-described embodiments, a method of selecting a detection block having a small error amount by RTS noise has been described as a means for changing the ratio of the weighted average in cyclic calculation. However, as another means for changing the ratio of the weighted average in cyclic calculation, the detection block readout order may be changed.

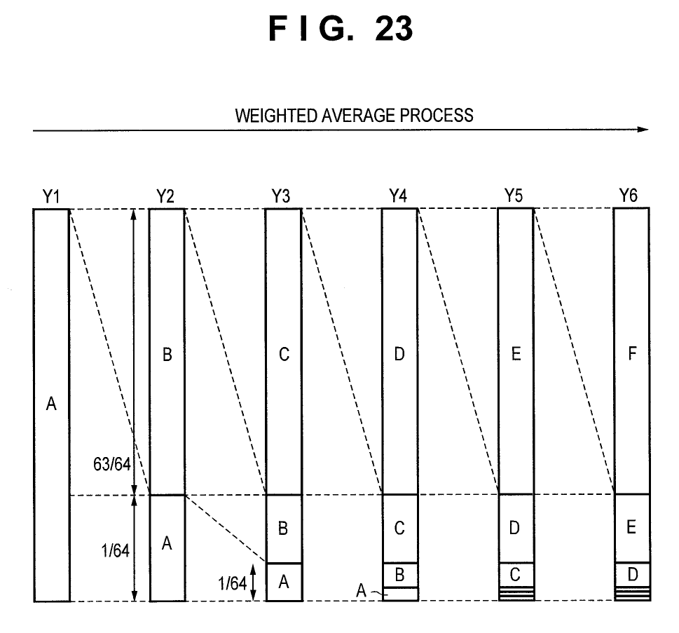

FIG. 23 shows a state in which when weighted average cyclic calculation is performed using an initial value Y1=A, K1=1/64, and K2=63/64 as cyclic coefficients in equation (1), the ratio of data of each row contained in the cyclic calculation value changes as cyclic calculation proceeds. Data of pixel signals on a specific column are represented by A, B, C, D, E, and F in order from the top of the row arrangement.

When attention is paid to the ratio of data A on the first row, the ratio is 1 (that is, all data A) in the first cyclic calculation value Y1, and decreases to (1/64) in the second cyclic calculation value Y2. In the third cyclic calculation value Y3, the ratio further decreases to 1/64 of the ratio in the second cyclic calculation value Y2. The ratio keeps decreasing as the cyclic calculation count increases. Even the ratio of data B on the second row similarly decreases at the ratio of (1/64) as the cyclic calculation count increases.

In this way, all data on respective rows similarly decrease at the ratio of (1/64) as the cyclic calculation count increases. As is apparent from the sixth cyclic calculation value Y6, the ratio of row data F read out later becomes highest, and that of row data A read out first becomes lowest. That is, the ratio is determined in the order of readout row data.

In the embodiment, the error amount by RTS noise is calculated for each detection block, and the detection block readout order in cyclic calculation is changed based on the error amount. A column offset is detected while decreasing the degree of influence of a detection block having a large error amount generated by RTS noise on the cyclic calculation value and increasing the degree of influence of a detection block having a small error amount.

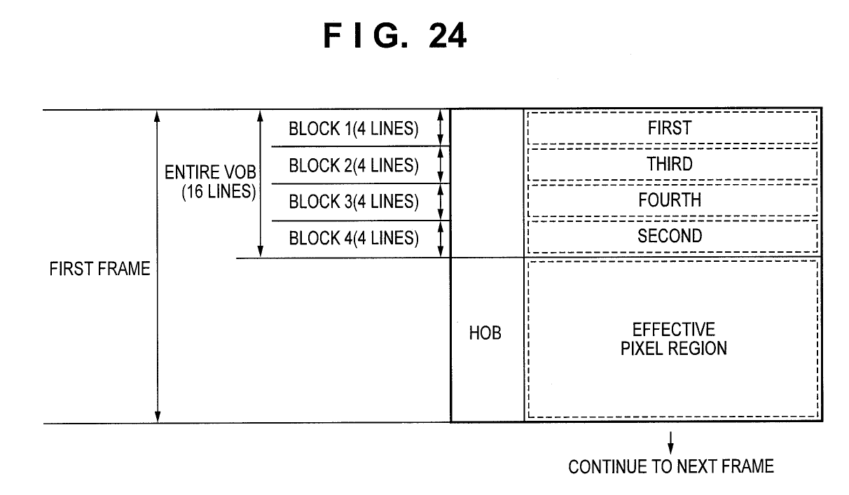

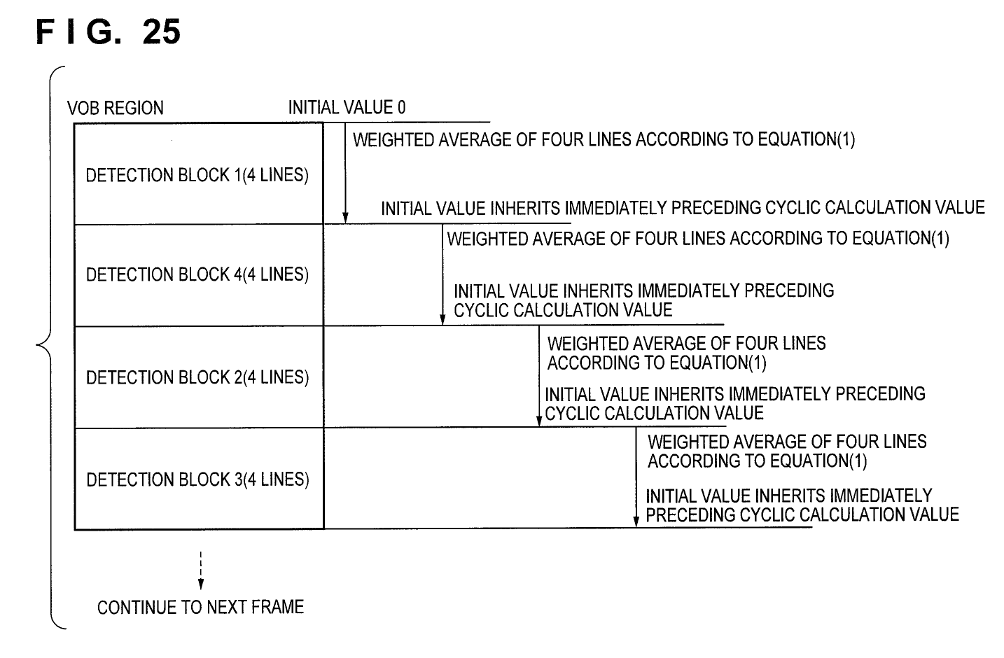

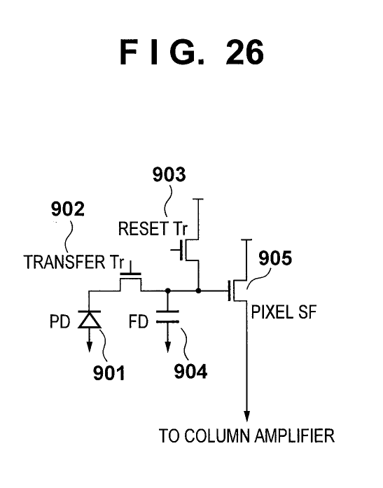

FIG. 24 shows the relationship between the VOB arrangement and divided detection blocks. FIG. 25 shows a state in which column offsets are detected from respective detection blocks by weighted average cyclic calculation to calculate correction data.

As shown in FIG. 24, a total of 16 lines are set in the VOB region. The VOB region is divided into four detection blocks each of four lines in the vertical direction.

The RTS noise occurrence frequency of an image sensor will be explained by exemplifying the use of an image sensor having the same characteristics as those in FIG. 9.

That is, a case in which the error amount of detection block 1 is extremely large and exceeds a permissible amount, those of detection blocks 2 to 4 fall within the permissible amount, that of detection block 3 is smallest, and the error amounts of the respective detection blocks are larger in the order of detection block 1, detection block 4, detection block 2, and detection block 3 will be described.

At the start of moving image shooting, detection block 1 considered to have a largest error amount based on the detection regions of the respective blocks regarding the RTS noise occurrence frequency of an image sensor that are stored in the image sensing apparatus is designated first as the VOB detection region.

In the first frame, the initial value of cyclic calculation equation (1) is set to 0, and the cyclic coefficients are set to K1=1/64 and K2=63/64. The weighted average is cyclically calculated repetitively four times using these cyclic coefficients, calculating the average value of four lines for each column within detection block 1. The average value detected from detection block 1 is inherited as the initial value of the next cyclic calculation.

Then, detection block 4 considered to have a second largest error amount is designated as the next detection region. The weighted average is cyclically calculated repetitively four times using the same cyclic coefficients, calculating the average value of four lines for each column within detection block 4. The average value detected from detection block 4 is inherited as the initial value of the next cyclic calculation.

Detection block 2 considered to have a third largest error amount is designated as the next detection region. The weighted average is cyclically calculated repetitively four times using the same cyclic coefficients, calculating the average value of four lines for each column within detection block 2. The average value detected from detection block 2 is inherited as the initial value of the next cyclic calculation.

Finally, detection block 3 considered to have a smallest error amount is designated as the next detection region. The weighted average is cyclically calculated repetitively four times using the same cyclic coefficients, calculating the average value of four lines for each column within detection block 3. The average value detected from detection block 3 is inherited as the initial value of the next cyclic calculation to the next frame. In addition, the average value is read out in the period of the vertical correction window signal VWCOL. The result is subtracted from the image sensing signal of the effective pixel region, removing the column offset.

The second frame inherits column offset data of the first frame as a cyclic calculation value. The average values are read out in the order of detection block 1, detection block 4, detection block 2, and detection block 3 each designated as the VOB region similarly, detecting column offsets. The results are subtracted from the image sensing signal of the effective pixel region, removing the column offsets.

Also, the third frame inherits column offset data of a preceding frame as a cyclic calculation value. The average values are read out in the order of detection block 1, detection block 4, detection block 2, and detection block 3 each designated as the VOB region similarly, detecting column offsets. The results are subtracted from the image sensing signal of the effective pixel region, removing the column offsets.

Subsequently, designation and readout of each detection block serving as the VOB region in each frame are repeated.

In this way, column offsets detected in respective frames are read out from respective detection blocks divided as the VOB region in descending order of the error amount generated by RTS noise. This decreases the degree of influence of a detection block having a large error amount while increasing that of influence of a detection block having a small error amount. An error amount contained in a finally detected column offset can be reduced to fall within the permissible amount.

Note that the above-described embodiments target a moving image. However, it is also possible to divide the detection region, and change the ratio of the weight in cyclic calculation for each divided detection block based on the detection result of the RTS noise occurrence frequency. When each frame of a moving image is regarded as a still image, the same effects can be obtained even for a still image according to the gist of the present invention to reduce an error amount generated by RTS noise and detect a column offset at high precision.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-098675, filed Apr. 26, 2011, which is hereby incorporated by reference herein in its entirety.

What is claimed is:

1. An image sensing apparatus which has an effective pixel portion in which a plurality of pixels are two-dimensionally arrayed in a row direction and a column direction, and a light-shielded pixel portion which is arranged at an end of the effective pixel portion in at least the column direction, the apparatus comprising:
a column offset detection unit configured to detect a column offset component for each column by performing weighted average cyclic calculation on the column at the light-shielded pixel portion;
a correction unit configured to correct a column offset superimposed at the effective pixel portion by performing cyclic calculation while a plurality of frames inherit the column offset component detected by said column offset detection unit, and subtracting a column offset component calculated in every cyclic calculation from an output signal of the effective pixel portion; and
a control unit configured to divide the light-shielded pixel portion into a plurality of blocks for each pixel region to be read out by one frame, and control a block to be read out for each frame.

2. The apparatus according to claim 1, wherein the light-shielded pixel portion is formed from a pixel which is read out via a pixel source follower while being shielded from light by a light-shielding film covering a photoelectric conversion element.

3. The apparatus according to claim 1, wherein the light-shielded pixel portion is formed from a pixel which is read out via a pixel source follower while a photoelectric conversion element is not electrically connected.

4. The apparatus according to claim 2, wherein the number of blocks at the light-shielded pixel portion is determined based on an occurrence frequency of RTS (Random Telegram Signal) noise generated by the pixel source follower.

5. The apparatus according to claim 4, wherein
said control unit controls to read out a signal from a predetermined block in each frame, and
the predetermined block is a block having a lowest occurrence frequency of the RTS noise out of the plurality of blocks.

6. The apparatus according to claim 1, wherein said control unit sets, as an initial value of the cyclic calculation by said correction unit, a column offset component detected from signals read out from all the blocks prior to readout of a first frame.

7. The apparatus according to claim 5, wherein said control unit detects the occurrence frequency of the RTS noise for each frame, and changes the predetermined block to a block having a lower occurrence frequency of the RTS noise.

8. The apparatus according to claim 5, wherein said control unit detects the occurrence frequency of the RTS noise for each frame, and when the occurrence frequency of the RTS noise exceeds a threshold, changes the predetermined block.

9. The apparatus according to claim 4, wherein said control unit selects a plurality of blocks in ascending order of occurrence frequency of the RTS noise, and changes the selected block between frames.

10. The apparatus according to claim 4, wherein said control unit detects the occurrence frequency of the RTS noise in each frame, and changes a readout order of a signal so as to read out from a block having a low occurrence frequency of the RTS noise later.

11. The apparatus according to claim 4, wherein said control unit detects the occurrence frequency of the RTS noise in each frame, and when the occurrence frequency of the RTS noise is larger than a threshold, changes an order of the blocks.

12. A control method of an image sensing apparatus which has an effective pixel portion at which a plurality of pixels are two-dimensionally arrayed in a row direction and a column direction, and a light-shielded pixel portion which is arranged at an end of the effective pixel portion in at least the column direction, the method comprising:
a column offset detection step of detecting a column offset component for each column by performing weighted average cyclic calculation on a single column at the light-shielded pixel portion;
a correction step of correcting a column offset superimposed at the effective pixel portion by performing cyclic calculation while a plurality of frames inherit the column offset component detected in the column offset detection step, and subtracting a column offset component calculated in every cyclic calculation from an output signal of the effective pixel portion; and
a control step of dividing the light-shielded pixel portion into a plurality of blocks for each pixel region to be read out by one frame, and controlling a block to be read out for each frame.

13. A computer-readable storage medium storing a program for causing a computer to execute the control method according to claim 12.
